(19) United States
(12) Patent Application Publication
(10) Pub. No.: US 2018/0005458 A1
(43) Pub. Date: Jan. 4, 2018

(54) INFORMATION PRESENTATION SYSTEM FOR EVALUATING BILLING LOCATION

(71) Applicant: MITSUBISHI HEAVY INDUSTRIES MECHATRONICS SYSTEMS, LTD., Kobe-shi, Hyogo (JP)

(72) Inventors: Masato IEHARA, Tokyo (JP); Ryota HIURA, Tokyo (JP); Takeshi FUKASE, Tokyo (JP); Takuma OKAZAKI, Tokyo (JP); Tetsuya ADACHI, Tokyo (JP)

(21) Appl. No.: 15/543,410

(22) PCT Filed: Jan. 15, 2015
(86) PCT No.: PCT/JP2015/050908

§ 371 Date: Jul. 13, 2017

(51) Int. Cl. G07B 15/06

(52) U.S. Cl. CPC G07B 15/06

(57) ABSTRACT

An information presentation system for evaluating a billing location includes a signal output unit mounted on a vehicle and configured to output a signal at a timing at which a billing process has been performed based on a location of the vehicle; a signal acquisition unit installed at a predetermined location and configured to acquire a signal from the signal output unit; and a billing location detection unit configured to detect a location at which the billing process has been performed based on the signal acquired by the signal acquisition unit.

### TECHNICAL FIELD

The present invention relates to an information presentation system for evaluating a billing location.

### BACKGROUND ART

As one of billing methods for toll roads and the like, a method of an on-vehicle device acquiring location information indicating its own location and performing a billing process based on the location has been proposed, which is called an autonomous billing method. For example, Patent Literature 1 describes an on-vehicle device system in which a Global Positioning System (GPS) is used to determine a location of a vehicle that is traveling and thereby automatic toll collection on toll roads is performed.

In an autonomous billing method, in order to prevent billing errors, it is necessary to obtain a location at which an on-vehicle device performs a billing process with accuracy. For example, it is conceivable that, when billing is performed at a predetermined billing point, an on-vehicle device needs to perform a billing process within a predetermined range before and after the billing point.

### CITATION LIST

### Patent Literature

### [Patent Literature 1]

Japanese Unexamined Patent Application First Publication No. H9-319904

### SUMMARY OF INVENTION

### Technical Problem

As a method of detecting a location at which a billing process has been performed in order to evaluate the accuracy of a location at which an on-vehicle device performs a billing process, for example, a method in which a high accuracy location determining device capable of specifying a location of a vehicle with high accuracy is mounted on the vehicle and a location of the vehicle when the on-vehicle device performs the billing process is recorded may be considered. For example, as the high accuracy location determining device, there is a device in which a GPS device, an inertial measurement unit (IMU), and a vehicle speed pulse are mounted and which can specify a location within an error range of several centimeters when the vehicle travels for several kilometers even in an environment in which the GPS device has been disrupted.

However, the high accuracy location determining device is expensive, for example, the price of a single device is tens of millions of yen, and evaluation costs are increased. In particular, when a high accuracy location determining device is installed in each of a plurality of vehicles in order to evaluate a location at which the billing process has been performed for the plurality of vehicles, costs significantly increase.

The present invention provides an information presentation system for evaluating a billing location through which it is possible to provide information for evaluating a location at which the billing process has been performed at relatively low cost.

### Solution to Problem

According to a first aspect of the present invention, an information presentation system for evaluating a billing location 1 includes a signal output unit 123 mounted on a vehicle 120 and configured to output a signal at a timing at which a billing process has been performed based on a location of the vehicle; signal acquisition units 131 and 132 installed at predetermined locations and configured to acquire a signal from the signal output unit; and a billing location detection unit 152 configured to detect a location at which the billing process has been performed based on the signal acquired by the signal acquisition unit.

Accordingly, in the information presentation system for evaluating a billing location according to the present invention, it is possible to provide information for evaluating a billing location at relatively low cost without an expensive device such as a high accuracy location determining device. In particular, in the information presentation system for evaluating a billing location according to the present invention, it is possible to detect whether a target location is included in a specific area with high accuracy without an expensive device.

The signal output unit may include a lighting device and output light as the signal. The signal acquisition unit may include a camera and capture an image including an image of the vehicle. The billing location detection unit may detect a location at which the billing process has been performed based on a location of an image of the vehicle which is included in the image and in which the lighting device is turned on.

Accordingly, in the information presentation system for evaluating a billing location according to the present invention, it is possible to provide information for evaluating a billing location using a relatively inexpensive device such as a lighting device and a camera.

The signal output unit may output a sound as the signal. The signal acquisition unit may include a microphone and acquire a sound from the signal output unit. The billing location detection unit may detect a location at which the billing process has been performed based on sound information acquired by the signal acquisition unit.

Accordingly, in the information presentation system for evaluating a billing location according to the present invention, it is possible to provide information for evaluating a billing location using a relatively inexpensive device such as a device configured to output a sound, for example, a speaker, and a microphone.

The signal output unit may output light having directionality as the signal. The signal acquisition unit may include a plurality of light receiving sensors that are provided along a traveling path of the vehicle and are able to acquire the light. The billing location detection unit may detect a location at which the billing process has been performed based on a light receiving sensor that is used for the signal acquisition unit to acquire the light.

Accordingly, in the information presentation system for evaluating a billing location according to the present invention, it is possible to provide information for evaluating a billing location using a relatively inexpensive device such as a device configured to output light having directionality and a light receiving sensor.

As the light having directionality, for example, a laser beam or light that has passed through a slit can be used.

Here, the billing location detection unit may detect a billing location based on a location of the light receiving sensor itself and may detect a billing location based on both a location of the light receiving sensor itself and a relative location of the billing location with respect to the light receiving sensor.

For example, the light receiving sensor and a location on the road according to the location at which the light receiving sensor is installed may be associated in advance. The billing location detection unit may detect a location on the road associated with the light receiving sensor that has acquired light as a billing location.

Further, a sensor capable of detecting a direction from which light is received may be used as the light receiving sensor. The billing location detection unit may detect a relative location of the billing location with respect to the light receiving sensor based on a direction from which the light receiving sensor receives light. Then, the billing location detection unit may correct the location on the road associated with the light receiving sensor that has acquired light based on a relative location of the billing location with respect to the light receiving sensor and set the corrected location as the billing location.

According to a second aspect of the present invention, an information presentation system for evaluating a billing location 2 includes a billing processing unit 221 configured to perform a billing process based on a location of a vehicle 220, a force detection unit 224 configured to detect a force applied to the vehicle due to a change in height of a surface provided at a predetermined location on a path along which the vehicle travels and a billing location detection unit 152 configured to detect a location at which the billing process has been performed based on a timing at which the billing processing unit performs the billing process and a timing at which the force detection unit detects the force applied.

Accordingly, in the information presentation system for evaluating a billing location according to the present invention, it is possible to provide information for evaluating a billing location at relatively low cost without an expensive device such as a high accuracy location determining device. In particular, in the information presentation system for evaluating a billing location, it is possible to detect whether a target location is included in a specific area with high accuracy without an expensive device.

The force detection unit may directly detect a force applied to the vehicle or may detect an acceleration or a change in acceleration, and thus a force applied to the vehicle may be detected.

The force detection unit may detect a force applied to the vehicle when traveling due to a change in height of the surface provided at two places on a path along which the vehicle travels. The billing location detection unit may detect whether a location at which the billing process has been performed is included in a range having the two places as two ends thereof.

Accordingly, the billing location detection unit can detect a location at which the billing process has been performed according to a simple operation of determining the relation between a timing at which the force detection unit detects a force applied and a time at which the billing process has been performed.

The force detection unit may detect a force applied to the vehicle when traveling due to a change in height of the surface that is additionally provided between the two places. The billing location detection unit may detect a section in which a location at which the billing process has been performed is included among sections of the path along which the vehicle travels that are separated by a change in height of the surface. Accordingly, the billing location detection unit can detect a location at which a billing process has been performed in a more detailed manner

According to a third aspect of the present invention, an information presentation system for evaluating a billing location 3 includes an imaging unit 326 mounted on a vehicle 320 and configured to image the outside from the vehicle at a timing at which a billing process has been performed based on a location of the vehicle.

Accordingly, in the information presentation system for evaluating a billing location according to the present invention, it is possible to provide information for evaluating a billing location at relatively low cost without an expensive device such as a high accuracy location determining device. In particular, in the information presentation system for evaluating a billing location, it is possible to provide information for determining whether a target location is included in a specific area without an expensive device.

The information presentation system for evaluating a billing location includes a storage unit 149 configured to store an image captured from a predetermined location and a billing location detection unit 352 configured to detect a location at which the billing process has been performed. The billing location detection unit may determine a relationship between a location at which the imaging unit performs imaging and a location at which an image stored in the storage unit is captured according to the association of images of the same object included in the image captured by the imaging unit and the image stored in the storage unit.

Accordingly, in the information presentation system for evaluating a billing location according to the present invention, it is possible to provide information about the location at which the billing process has been performed to a user. In particular, the user can more easily determine the location at which the billing process has been performed than when an image captured by the imaging unit from the location at which the billing process has been performed is provided.

A predetermined marker may be provided at a predetermined reference location.

Accordingly, in the information presentation system for evaluating a billing location according to the present invention, it is possible to provide information for evaluating a billing location according to a relatively simple process in which it is determined whether an image of the predetermined marker is included in the image captured by the imaging unit, and when the image is included, a location of the image of the marker in the image is determined.

A predetermined marker may be provided above a path along which the vehicle travels. The imaging unit may be installed pointing upward and perform imaging.

Above the road, a field of view is not blocked in other directions so that the imaging unit can capture an image of the marker more reliably. Accordingly, it is possible to reduce a likelihood of failing to detect a billing location.

### Advantageous Effects of Invention

According to the above-described information presentation system for evaluating a billing location, it is possible to provide information for evaluating a location at which a billing process has been performed at a relatively low cost.

### BRIEF DESCRIPTION OF DRAWINGS

FIG. 1 is a schematic block diagram showing a functional configuration of an information presentation system for evaluating a billing location according to a first embodiment of the present invention.

FIG. 2 is an explanatory diagram showing a camera arrangement example in the first embodiment.

FIG. 3 is an explanatory diagram showing a first example of an image captured by a camera 131 in the first embodiment.

FIG. 4 is an explanatory diagram showing a second example of an image captured by the camera 131 in the first embodiment.

FIG. 5 is an explanatory diagram showing a first example of an image captured by a camera 132 in the first embodiment.

FIG. 6 is an explanatory diagram showing a second example of an image captured by the camera 132 in the first embodiment.

FIG. 7 is a flowchart showing an example of processing procedures performed by a device mounted on a vehicle in the first embodiment.

FIG. 8 is a flowchart showing an example of processing procedures in which a control unit generates information for evaluating the accuracy of a billing location in the first embodiment.

FIG. 9 is an explanatory diagram showing an example of a screen displayed on a display unit in order to detect a billing location and a billing time in the first embodiment.

FIG. 10 is an explanatory diagram showing an example of a screen displayed on a display unit after an image of a vehicle is selected in the first embodiment.

FIG. 11 is an explanatory diagram showing an example of a screen displayed on a display unit after a row in billing information is selected in the first embodiment.

FIG. 12 is an explanatory diagram showing an example of a screen displayed on a display unit after a result save button is pressed in the first embodiment.

FIG. 13 is an explanatory diagram showing an example of a microphone installation location when a sound is used as a signal in a modification of the first embodiment.

FIG. 14 is an explanatory diagram showing an example of a light receiving sensor array installation location when a laser beam is used as a signal in the modification of the first embodiment.

FIG. 15 is a schematic block diagram showing a functional configuration of an information presentation system for evaluating a billing location in a second embodiment of the present invention.

FIG. 16 is an explanatory diagram showing an example of a change in height provided on a surface of a road in the second embodiment.

FIG. 17 is a diagram showing a first example of a relationship between a time at which an acceleration changes and a billing time in the second embodiment.

FIG. 18 is an explanatory diagram showing a second example of a relationship between a time at which an acceleration changes and a billing time in the second embodiment.

FIG. 19 is an explanatory diagram showing a third example of a relationship between a time at which an acceleration changes and a billing time in the second embodiment.

FIG. 20 is a flowchart showing an example of a processing procedure performed by a device mounted on a vehicle in the second embodiment.

FIG. 21 is a flowchart showing an example of a processing procedure in which a control unit generates information for evaluating the accuracy of a billing location in the second embodiment.

FIG. 22 is an explanatory diagram showing an example of a screen displayed on a display unit in order to detect a billing location in the second embodiment.

FIG. 23 is an explanatory diagram showing an example of a screen displayed on a display unit before a row in billing information is selected in the second embodiment.

FIG. 24 is an explanatory diagram showing an example of a screen displayed on a display unit after a row in billing information is selected in the second embodiment.

FIG. 25 is an explanatory diagram showing an example of a screen displayed on a display unit after a billing allowable range start position passing time and a billing allowable range end position passing time are selected in the second embodiment.

FIG. 26 is an explanatory diagram showing an example of a road in which a height of a surface changes at three or more places in a modification of the second embodiment.

FIG. 27 is an explanatory diagram showing an example of an acceleration history when a change in surface height is provided at three or more places in a road in the modification of the second embodiment.

FIG. 28 is a schematic block diagram showing a functional configuration of an information presentation system for evaluating a billing location in a third embodiment of the present invention.

FIG. 29 is an explanatory diagram showing an example of an image captured by a camera in the third embodiment.

FIG. 30 is an explanatory diagram showing a first example of a positional relationship when an image captured from a billing allowable range start position and an image captured by a camera are superimposed in the third embodiment.

FIG. 31 is an explanatory diagram showing a second example of a positional relationship when an image captured from a billing allowable range start position and an image captured by a camera are superimposed in the third embodiment.

FIG. 32 is an explanatory diagram showing a first example of a positional relationship when an image captured from a billing allowable range end position and an image captured by a camera are superimposed in the third embodiment.

FIG. 33 is an explanatory diagram showing a second example of a positional relationship when an image captured from a billing allowable range end position and an image captured by a camera are superimposed in the third embodiment.

FIG. 34 is a flowchart showing an example of a processing procedure performed by a device mounted on a vehicle in the third embodiment.

FIG. 35 is a flowchart showing an example of a processing procedure in which a control unit generates information for evaluating the accuracy of a billing location in the third embodiment.

FIG. 36 is an explanatory diagram showing an example of a screen displayed on a display unit in order to detect a billing location in the third embodiment.

FIG. 37 is an explanatory diagram showing an example of a screen displayed on a display unit before a row in billing information is selected in the third embodiment.

FIG. 38 is an explanatory diagram showing an example of a screen displayed on a display unit after a row in billing information is selected in the third embodiment.

FIG. 39 is an explanatory diagram showing an example of a screen displayed on a display unit after an image captured by a camera and an image captured from a billing allowable range start position or an image captured from a billing allowable range end position are aligned in the third embodiment.

FIG. 40 is an explanatory diagram showing an example of an image captured by a camera when a marker is installed on the roadside in a modification of the third embodiment.

FIG. 41 is an explanatory diagram showing an example of an image captured by a camera when a marker is installed above the road in the modification of the third embodiment.

### EMBODIMENTS FOR CARRYING OUT THE INVENTION

Embodiments of the present invention will be described below, but the following embodiments do not limit the invention according to the scope of claims. In addition, not all combinations of features described in the embodiments are necessary for the solving means of the invention.

### First Embodiment

### Configuration and Operations in First Embodiment

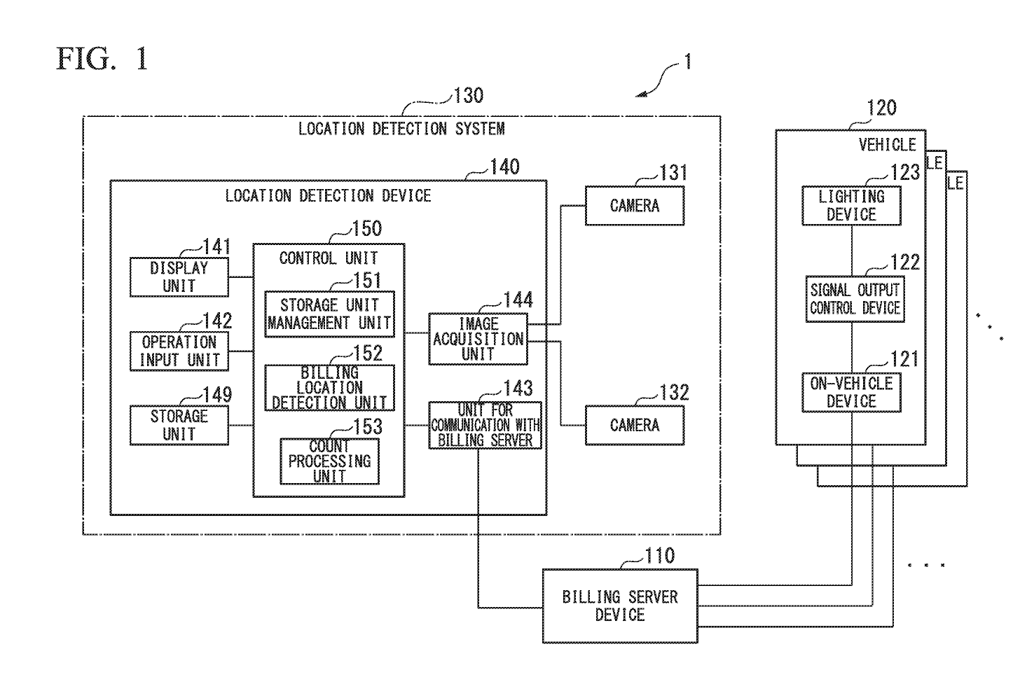

FIG. 1 is a schematic block diagram showing a functional configuration of an information presentation system for evaluating a billing location according to a first embodiment of the present invention. In FIG. 1, an information presentation system for evaluating a billing location 1 includes a billing server device 110, a vehicle 120, and a location detection system 130. The vehicle 120 includes an on-vehicle device 121, a signal output control device 122, and a lighting device 123. The location detection system 130 includes a camera 131, a camera 132, and a location detection device 140. The location detection device 140 includes a display unit 141, an operation input unit 142, a unit for communication with a billing server 143, an image acquisition unit 144, a storage unit 149, and a control unit 150. The control unit 150 includes a storage unit management unit 151, a billing location detection unit 152, and a count processing unit 153.

The information presentation system for evaluating a billing location 1 is a system for evaluating the accuracy of a location at which the on-vehicle device 121 performs a billing process. A billing point is set in the information presentation system for evaluating a billing location 1, and when the vehicle 120 passes the billing point, the on-vehicle device 121 performs the billing process. Then, the location detection system 130 provides information for evaluating a location at which the on-vehicle device 121 performs the billing process.

The billing point here is a location set as a reference at which billing is performed, and billing is performed for a vehicle that passes the billing point. For example, the billing point may be set as a line having a length in a width direction on the road, and a predetermined range before and after the billing point may be set as a billing allowable range.

For example, according to requirement specifications of an automatic billing system, a rate at which the on-vehicle device 121 performs the billing process within the billing allowable range is requested to be a predetermined rate or more. The information presentation system for evaluating a billing location 1 provides information for evaluating whether the request is satisfied.

Here, a location at which the on-vehicle device 121 performs the billing process is referred to as a “billing location.”

The billing server device 110 communicates with the on-vehicle device 121, and acquires and stores billing information. The “billing information” here is information about the billing process performed by the on-vehicle device 121. In the billing information, an on-vehicle device ID (identification information of an on-vehicle device), billing time information (information indicating a time at which the billing server device 110 performs the billing process), and billing amount information are included. The “billing time” here is a time at which billing is performed.

The vehicle 120 is a billing target vehicle that can travel on a road, for example, an automobile or a two-wheeled vehicle. The number of vehicles 120 provided for the information presentation system for evaluating a billing location 1 may be one or more. Meanwhile, when the information presentation system for evaluating a billing location 1 is provided for a plurality of vehicles 120, it is possible to evaluate the billing location in a situation close to an actual billing situation in which a plurality of vehicles 120 are traveling at the same time.

The on-vehicle device 121 is an on-vehicle device that includes, for example, a global navigation satellite system (GNSS) receiver, acquires vehicle location information, and performs the billing process based on a location of a vehicle. The on-vehicle device 121 outputs a signal indicating execution of the billing process to the signal output control device 122 at a timing at which the billing process has been performed. The timing at which the billing process has been performed here is not strictly the same time as when the billing process has been performed, and may be immediately before the billing process or immediately after the billing process.

In addition, the on-vehicle device 121 transmits billing information to the billing server device 110. A timing at which the on-vehicle device 121 transmits billing information is arbitrary. For example, the on-vehicle device 121 may collect billing information over a predetermined time in a predetermined time period and transmit the collected information to the billing server device 110. Alternatively, the on-vehicle device 121 may transmit billing information immediately after the billing process has been performed.

The signal output control device 122 controls the lighting device 123. In particular, the signal output control device 122 lights up the lighting device 123 when a signal indicating execution of the billing process is acquired from the on-vehicle device 121. In order to connect the signal output control device 122 to the on-vehicle device 121, it is conceivable to use a port that is generally provided in the on-vehicle device 121, for example, a Universal Serial Bus (USB) port. Accordingly, it is possible to easily connect the signal output control device 122 to the on-vehicle device 121.

The lighting device 123 lights up under control of the signal output control device 122. Accordingly, the lighting device 123 outputs an optical signal at a timing at which the billing process has been performed based on a location of the vehicle 120. The lighting device 123 corresponds to an example of a signal output unit.

The location detection system 130 detects the billing location based on a signal from the lighting device 123 and provides information for evaluating the accuracy of the detected location.

The camera 131 is installed on the side of the road toward a start position of a billing allowable range, and images the vehicle 120 that travels near the billing allowable range start position. The camera 132 is installed on the side of the road toward an end position of the billing allowable range, and images the vehicle 120 that travels near the billing allowable range end position.

Here, the start position of the billing allowable range is referred to as a “billing allowable range start position.” In addition, the end position of the billing allowable range is referred to as a “billing allowable range end position.”

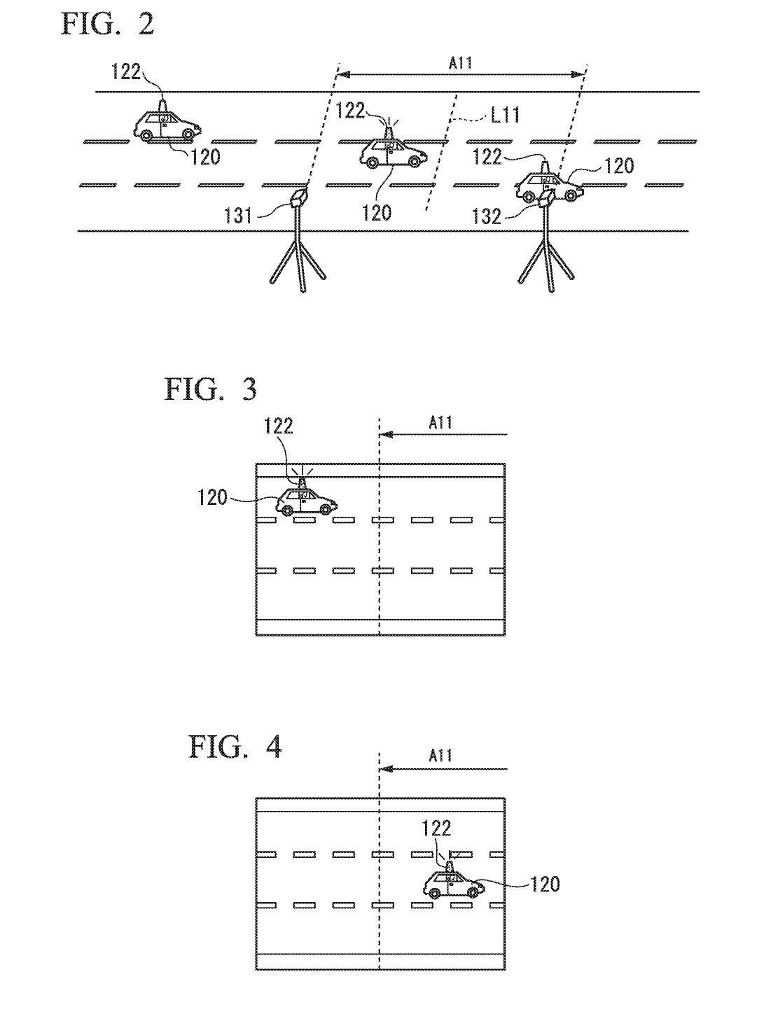

FIG. 2 is an explanatory diagram showing an arrangement example of the cameras 131 and 132. In FIG. 2, a line L11 indicates the billing point, and an area A11 indicates a billing allowable range. Here, the line L11 and the area A11 are illustrated only for description. There is no need to display the billing point and the billing allowable range on the road.

The camera 131 is installed just beside the billing allowable range start position facing toward the billing allowable range start position so that the billing allowable range start position is located at the center of the screen.

FIG. 3 is an explanatory diagram showing a first example of an image captured by the camera 131. As shown in FIG. 3, the billing allowable range start position is located to extend vertically at the center of the image captured by the camera 131. Therefore, it is possible to determine that the vehicle 120 captured on the left side of the image is located outside the billing allowable range. Furthermore, the lighting device 123 of the vehicle 120 is turned on, and it is possible to determine that the billing process has been performed outside the billing allowable range.

Note that a case in which the lighting device 123 is turned on only for a short time will be exemplified below. In this case, the lighting device 123 can be brightly lit relatively easily.

On the other hand, the lighting device 123 may remain on. In this case, when it is determined whether the lighting device 123 is turned on at each of the billing allowable range start position and the billing allowable range end position, even if the state of the lighting device 123 within the billing allowable range is unknown, it is possible to determine whether billing is performed within the billing allowable range.

FIG. 4 is an explanatory diagram showing a second example of an image captured by the camera 131. In FIG. 4, the vehicle 120 has been captured on the right side of the image, and it is possible to determine that the vehicle 120 is located within the billing allowable range. Furthermore, the lighting device 123 of the vehicle 120 is turned on, and it is possible to determine that the billing process has been performed within the billing allowable range.

The camera 132 is installed just beside the billing allowable range end position facing toward the billing allowable range end position so that the billing allowable range end position is located at the center of the screen.

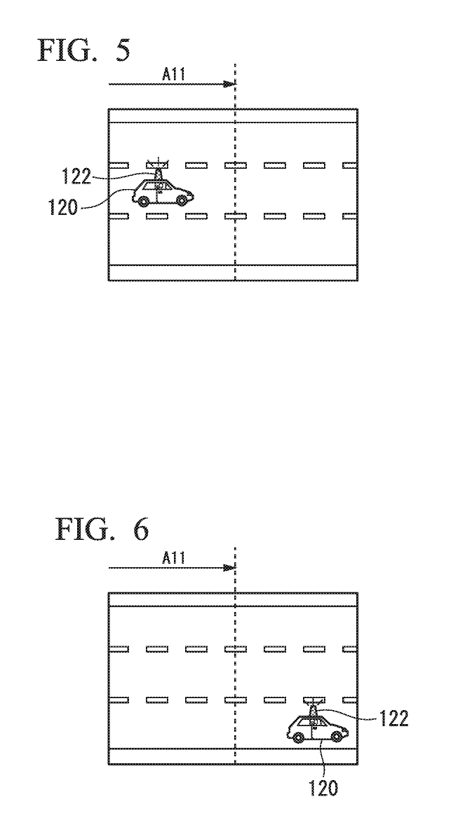

FIG. 5 is an explanatory diagram showing a first example of an image captured by the camera 132. As shown in FIG. 5, the billing allowable range end position is located to extend vertically at the center of the image captured by the camera 132. Therefore, it is possible to determine that the vehicle 120 captured on the left side of the image is located within the billing allowable range. Furthermore, the lighting device 123 of the vehicle 120 is turned on, and it is possible to determine that the billing process has been performed within the billing allowable range.

FIG. 6 is an explanatory diagram showing a second example of an image captured by the camera 132. In FIG. 6, the vehicle 120 is captured on the right side of the image, and it is possible to determine that the vehicle 120 is located outside the billing allowable range. Furthermore, the lighting device 123 of the vehicle 120 is turned on, and it is possible to determine that the billing process has been performed outside the billing allowable range.

In this manner, it is possible to determine whether the billing process has been performed within the billing allowable range using the image captured by the camera 131 and the image captured by the camera 132. Here, when the lighting device 123 is turned on only for a short time, the cameras 131 and 132 image the entire billing allowable range. Therefore, the cameras 131 and 132 are installed at positions in which edges of the images are superimposed.

The cameras 131 and 132 correspond to an example of a signal acquisition unit, are installed at predetermined locations just beside the billing allowable range start position and just beside the billing allowable range end position, and acquire a signal from the lighting device 123. The “predetermined locations” of the cameras refer to, for example, locations of both ends of an allowable error range (“billing allowable range” in this embodiment) with respect to a billing point location (a location in a direction of travel). In addition, while the “predetermined location” is generally the roadside, it may be a location away from the road to some extent as long as a vehicle on the road can be imaged at the location.

The location detection device 140 detects the billing location based on images captured by the cameras 131 and 132 and provides information for evaluating the accuracy of the detected billing location. The location detection device 140 may detect whether the billing location is within the billing allowable range, and may detect a more detailed location. The location detection device 140 may include, for example, a computer.

The display unit 141 includes, for example, a display screen such as a liquid crystal panel, and displays various images. In particular, the display unit 141 provides information for evaluating the accuracy of the billing location, for example, a rate at which the billing process has been performed within the billing allowable range.

In addition, as will be described below, when a user specifies the billing location, the display unit 141 displays images captured by the cameras 131 and 132.

The operation input unit 142 includes an input device, for example, a keyboard and a mouse, and receives a user operation. In particular, as will be described below, when the user specifies the billing location, the operation input unit 142 receives an operation with respect to a screen display of the display unit 141 and an operation indicating the billing location.

The unit for communication with a billing server 143 communicates with the billing server device 110 and transmits and receives various types of information. In particular, the unit for communication with a billing server 143 acquires billing information from the billing server device 110.

The image acquisition unit 144 functions as an interface for the cameras 131 and 132 and acquires an image captured by the cameras 131 and 132 as image data.

The storage unit 149 includes a storage device of the location detection device 140 and stores various types of information. In particular, the storage unit 149 stores image data acquired by the image acquisition unit 144 and billing information acquired by the billing server device 110.

The control unit 150 controls components of the location detection device 140 and performs various processes. The control unit 150 is implemented, for example, when a central processing unit (CPU) of the location detection device 140 reads and executes a program from the storage unit 149.

The storage unit management unit 151 writes information in the storage unit 149, searches for information stored in the storage unit 149, and reads information from the storage unit 149.

The billing location detection unit 152 detects the billing location based on images captured by the cameras 131 and 132. The billing location detection unit 152 may detect whether the billing location is within the billing allowable range, and may detect a more detailed location.

Here, as described with reference to FIGS. 3 to 6, when the cameras 131 and 132 are installed at predetermined locations, it is possible to determine whether the vehicle 120 is located within the billing allowable range based on a location of the image of the vehicle 120 in the image. In this regard, the billing location detection unit 152 detects the billing location based on the locations of the cameras 131 and 132. The billing location detection unit 152 corresponds to an example of the billing location detection unit.

The count processing unit 153 counts the instances in which the billing location detected by the billing location detection unit 152 is within the billing allowable range and outside the billing allowable range, and calculates a rate at which the billing process has been performed within the billing allowable range.

### Operations in First Embodiment

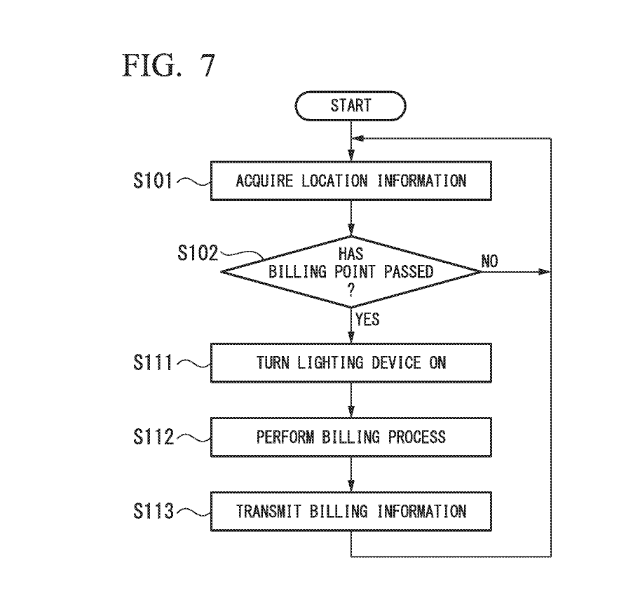

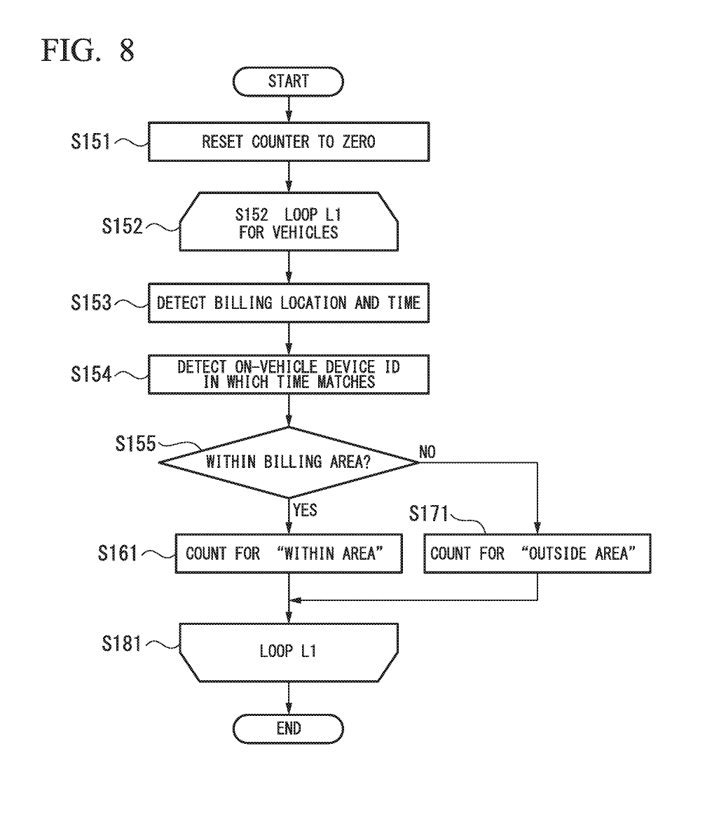

Next, operations of the information presentation system for evaluating a billing location 1 will be described with reference to FIGS. 7 and 8.

FIG. 7 is a flowchart showing an example of processing procedures performed by a device mounted on the vehicle 120. The on-vehicle device 121, the signal output control device 122, and the lighting device 123 start the process in FIG. 7, for example, when their power sources are turned on and they are activated.

In the process in FIG. 7, the on-vehicle device 121 acquires location information (Step S101). For example, the on-vehicle device 121 includes a GNSS receiver, and calculates the location of the on-vehicle device 121 itself as a location of the vehicle 120.

Next, the on-vehicle device 121 determines whether the vehicle 120 has passed the billing point and the billing process has not been performed during the passing based on location information of the vehicle 120 obtained in Step S101 (Step S102).

When it is determined that no vehicles 120 have passed or the billing process has been performed (NO in Step S102), the process returns to Step S101.

On the other hand, when it is determined that a vehicle 120 has passed the billing point and the billing process has not been performed during passing (YES in Step S102), the on-vehicle device 121 outputs a signal indicating execution of the billing process to the signal output control device 122, and the lighting device 123 is turned on under control of the signal output control device 122 (Step S111).

In addition, the on-vehicle device 121 performs the billing process, and generates billing information of the billing process (Step S112). Then, the on-vehicle device 121 transmits the generated billing information to the billing server device 110 (Step S113).

After Step S113, the process returns to Step S101.

FIG. 8 is a flowchart showing an example of processing procedures in which the control unit 150 generates information for evaluating the accuracy of the billing location. For example, the control unit 150 starts the process in FIG. 8 when a user operation instructing generation of the information is performed.

In the process in FIG. 8, the count processing unit 153 resets values of a counter for within the billing allowable range and a counter for outside the billing allowable range to zero (Step S151).

Next, the control unit 150 starts a loop L1 in which processing is performed on each of the vehicles 120 imaged by the cameras 131 and 132 (Step S152). A vehicle to be processed in a loop will be referred to as a “target vehicle” below.

In the loop L1, the billing location detection unit 152 detects a lighting start position and a lighting start time of the lighting device 123 of the target vehicle (Step S153). The lighting start position and the lighting start time may be automatically detected by the billing location detection unit 152 or may be detected upon reception of a user operation.

When the lighting start time and the lighting start position are automatically detected, the billing location detection unit 152 detects a frame in which the lighting device 123 of the target vehicle has commenced to be turned on from the images captured by the cameras 131 and 132. For example, the billing location detection unit 152 extracts an area of the image of the vehicle 120 from frames using a background subtraction method.

Then, the billing location detection unit 152 performs difference processing on pixel values with respect to frames whose imaging times are close for the extracted area. When the lighting device 123 is initially lit up, there is a large difference in the lighting device 123 portion. Therefore, when the size of a difference area is equal to or larger than a certain value, the billing location detection unit 152 determines that the lighting device 123 has been turned on.

Then, the billing location detection unit 152 determines whether a location of the target vehicle is within the billing allowable range using the method described with reference to FIGS. 3 to 6 and acquires the determination result as billing location information. In addition, the billing location detection unit 152 acquires an imaging time of the detected frame as billing time information.

Here, the billing location detection unit 152 may obtain a more detailed billing location.

For example, in addition to the above process, the billing location detection unit 152 may detect an image when the target vehicle passes the billing allowable range start position and acquire an imaging time of the image as a billing allowable range start position passing time. In addition, the billing location detection unit 152 may detect an image when the target vehicle passes the billing allowable range end position and acquire an imaging time of the image as a billing allowable range end position passing time. Then, the billing location detection unit 152 obtains a ratio between a time from when the billing allowable range start position has passed until lighting up and a time from when lighting starts until the billing allowable range end position has passed.

Furthermore, the billing location detection unit 152 determines that the billing process has been performed at a location of progression according to the obtained ratio within the entire billing allowable range and calculates the billing location. Accordingly, the billing location detection unit 152 obtains the billing location when the target vehicle travels within the billing allowable range at almost a constant speed in a more detailed manner.

After Step S153, the billing location detection unit 152 detects information about billing of the target vehicle from billing information and associates it with the billing location obtained in Step S153 (Step S154). Specifically, the billing location detection unit 152 detects information about billing in which the lighting start time obtained in Step S153 matches a billing time from billing information. Then, the billing location detection unit 152 stores the obtained information about billing and the billing location information obtained in Step S153 in association in the storage unit 149.

Here, as will be described below, the billing location detection unit 152 may perform the process of Step S153 as well as the process of Step S154 upon reception of a user operation.

Here, when the association of the billing information and the billing location is unnecessary, the billing location detection unit 152 may not perform the process of Step S154.

Next, the count processing unit 153 determines whether the billing location obtained in Step S153 is within the billing allowable range (Step S155). When it is determined that the billing location is within the billing allowable range (YES in Step S155), the count processing unit 153 increases the value of the counter for within the billing allowable range by one (Step S161).

Then, the control unit 150 performs a termination process of the loop L1 (Step S181). Specifically, the control unit 150 determines whether there are vehicles 120 that have not completed the process of the loop L1 among the vehicles 120 captured in the image to be processed. When it is determined that there is a vehicle 120 that has not completed the process, the process returns to Step S151, and the process is performed on the vehicle 120 that has not completed the process. On the other hand, when it is determined that there are no vehicles 120 that have not completed the process, the loop L1 ends.

After the loop L1 ends, the process of FIG. 8 ends.

On the other hand, in Step S155, when it is determined that the billing location obtained in Step S153 is outside the billing allowable range (NO in Step S155), the count processing unit 153 increases the value of the counter for outside the billing allowable range by one (Step S171).

After Step S171, the process advances to Step S181.

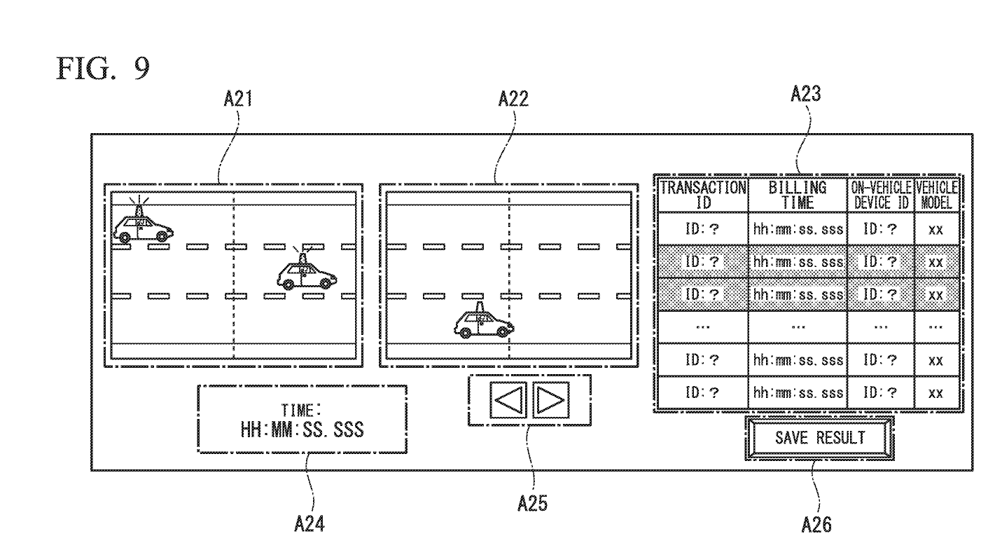

Next, the processes in which the billing location detection unit 152 receives a user operation and detects a billing location and a billing time will be described with reference to FIGS. 9 to 12. The billing location detection unit 152 performs, for example, the following process as the process in Step S153 in FIG. 8.

FIG. 9 is an explanatory diagram showing an example of a screen displayed on the display unit 141 in order to detect the billing location and the billing time.

In the example in FIG. 9, the display unit 141 displays one frame of the image captured by the camera 131 on an area A21. In addition, the display unit 141 displays a frame at the same imaging time as the frame of the area A21 within the image captured by the camera 132 on an area A22. In addition, the display unit 141 displays imaging times of the frame displayed on the area A21 and the frame displayed on the area A22 on an area A24.

In addition, the display unit 141 displays billing information on an area A23. The billing information shown in the area A23 is shown in a table format, and one row shows information about one instance of billing. In addition, each row includes items of a transaction ID, a billing time, an on-vehicle device ID and a vehicle model.

The transaction ID is identification information for identifying each billing. A time at which corresponding billing is performed, identification information of the on-vehicle device 121 that performs corresponding billing, and information about the vehicle model of the vehicle 120 that is a target for corresponding billing are stored in the columns of the billing time, the on-vehicle device ID, and the vehicle model, respectively.

In the billing information shown in the area A23, a row in which billing is performed at a time shown in the area A24 is displayed distinguishably from other rows.

In addition, the display unit 141 displays an operation button for moving the time forward or backward on an area A25. In addition, the display unit 141 displays an operation button for instructing the result of the process to be saved on an area A26.

In the screen shown in FIG. 9, the user selects the image of the vehicle 120 in which the lighting device 123 has commenced to be turned on. That is, the user selects the image of the vehicle 120 in which the lighting device 123 was turned off in the previous frame within the image of the vehicle 120 in which the lighting device 123 is turned on.

The billing location detection unit 152 detects the billing location based on a location of the selected image of the vehicle 120 in the same manner as when the process of Step S153 is automatically performed. In addition, the billing location detection unit 152 acquires a time displayed on the area A24 as the billing time.

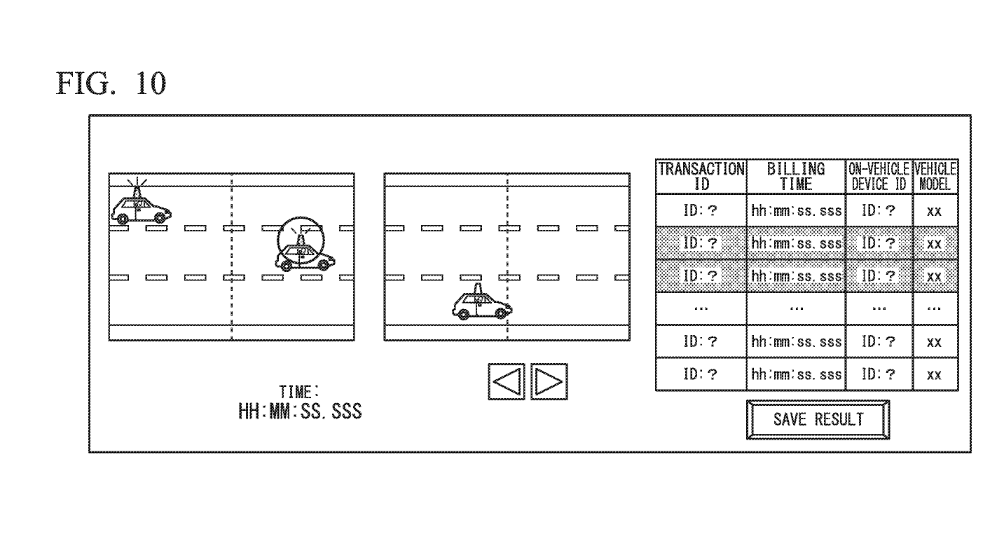

FIG. 10 is an explanatory diagram showing an example of a screen displayed on the display unit 141 after an image of the vehicle 120 is selected. In FIG. 10, the display unit 141 displays the selected image of the vehicle 120 with a mark. Accordingly, the user can confirm that selection is performed correctly and it is possible to reduce errors in operation.

In addition, in response to the operation of Step S154 in FIG. 9, the user selects a row indicating billing for the vehicle 120 whose image is selected from among rows in billing information. In the billing information, when there are a plurality of rows in which a billing time and an imaging time match, the user selects any row based on, for example, vehicle model information. On the other hand, when there is only one row in which a billing time and an imaging time match, the billing location detection unit 152 may automatically select the row.

Here, when the association of the billing information and the billing location is unnecessary, it is not necessary to select a row in billing information.

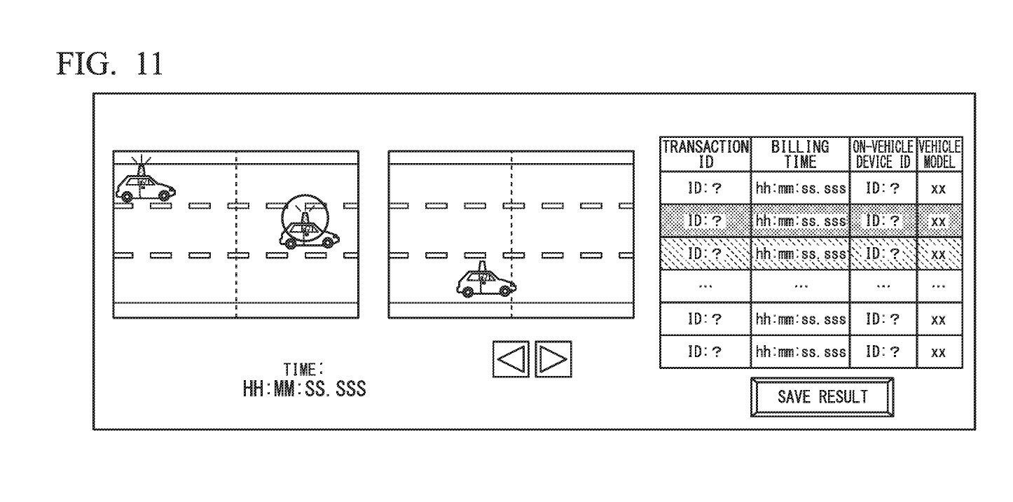

FIG. 11 is an explanatory diagram showing an example of a screen displayed on the display unit 141 after a row in billing information is selected. In FIG. 11, the display unit 141 displays the selected row distinguishably from other rows. Accordingly, the user can confirm that a selection is performed correctly and it is possible to reduce errors in operation.

When selecting the image of the vehicle 120 and a row in billing information have been completed, the user presses a result save button (for example, clicks a mouse) to confirm the selection.

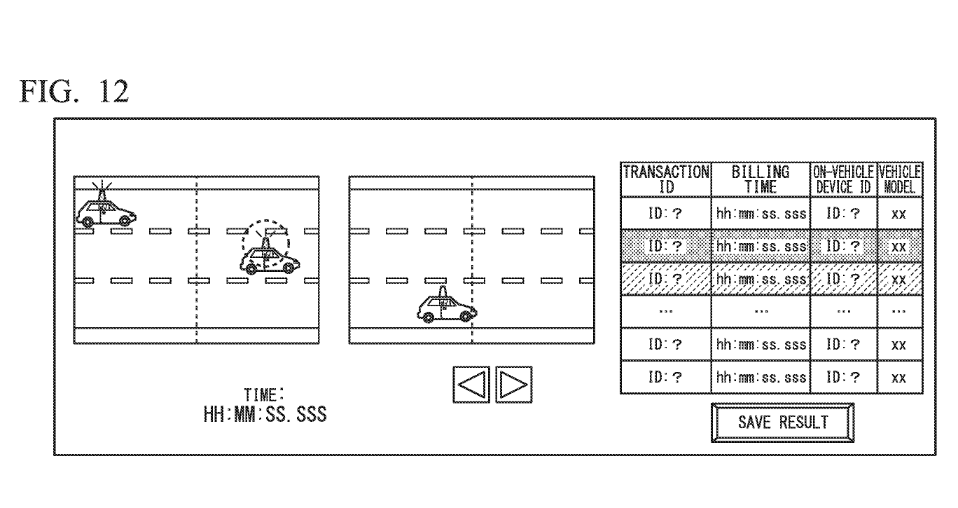

FIG. 12 is an explanatory diagram showing an example of a screen displayed on the display unit 141 after a result save button is pressed. In FIG. 12, the display unit 141 displays the selected image and the selected row distinguishably from the others.

The process (here, one process of Steps S153 and S154) for one vehicle 120 has been completed above.

Further, similarly, the processes of Steps S153 and S154 are performed on another target vehicle in the loop L1.

Specifically, from the state of the screen in FIG. 12, the user performs the same operation as above for another vehicle 120 whose image is displayed. When there are no other vehicles 120 in which the lighting device 123 has commenced to be turned on in the displayed image, the user operates an operation button of the area A25 (FIG. 9) and performs the same process for all times at which an image is obtained.

As described above, the lighting device 123 is mounted on the vehicle 120 and outputs an optical signal at a timing at which the billing process has been performed based on the location of the vehicle 120. In addition, the camera 131 and the camera 132 are installed at predetermined locations and acquire a signal from the lighting device 123. Thus, the billing location detection unit 152 detects a location at which the billing process has been performed based on the signal acquired by the camera 131 and the camera 132. More specifically, the billing location detection unit 152 detects the location of the lighting device 123 that outputs light based on at least either of the image captured by the camera 131 or the image captured by the camera 132 and thus detects the billing location.

Accordingly, in the information presentation system for evaluating a billing location 1, it is possible to provide information for evaluating the billing location at relatively low cost without an expensive device such as a high accuracy location determining device.

Here, a high accuracy location determining device needs adjustment when installed in a vehicle. In particular, when a high accuracy location determining device is installed in each of a plurality of vehicles in order to evaluate the billing location for the plurality of vehicles, there is a high burden on an operator who performs adjustment.

On the other hand, in the information presentation system for evaluating a billing location 1, there is no need to perform special adjustment of a device to be mounted on the vehicle 120. In particular, even when the billing location is evaluated for a plurality of vehicles, the burden on an operator who installs the device in the vehicles 120 is relatively small.

In addition, the lighting device 123 outputs light as a signal, and the cameras 131 and 132 capture an image including the image of the vehicle 120. Then, the billing location detection unit 152 detects a location at which the billing process has been performed based on the location of the image of the vehicle 120 in which the lighting device 123 is turned on included in the image captured by the cameras 131 and 132.

In this manner, when the cameras 131 and 132 which are examples of the signal acquisition unit capture images, it is possible to acquire a signal not only in one direction but also in a range of angles of view. Accordingly, the number of signal acquisition units included in the information presentation system for evaluating a billing location 1 is reduced. In this regard, it is possible to simplify the configuration of the information presentation system for evaluating a billing location 1 and it is possible to reduce the burden on an operator who installs the signal acquisition units.

Here, near infrared light may be used for the lighting device 123, and near infrared cameras may be used as the cameras 131 and 132. When near infrared light is used for the lighting device 123, it is possible to prevent other drivers around the vehicle from being dazzled during lighting. In addition, when near infrared cameras are used as the cameras 131 and 132, it is possible to image turning on of the lighting device 123 relatively easily even under direct sunlight.

### Modification of First Embodiment

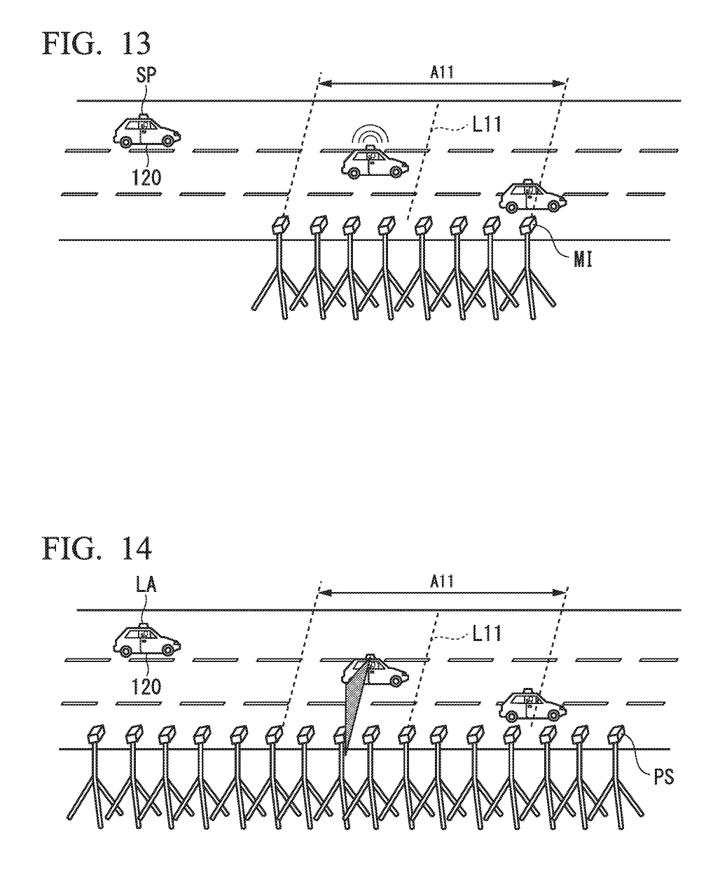

The information presentation system for evaluating a billing location 1 may use other signals instead of or in addition to light output from the lighting device 123. This will be described with reference to FIG. 13 and FIG. 14.

FIG. 13 is an explanatory diagram showing an example of a microphone installation location when a sound is used as a signal. When a sound is used as a signal, a speaker SP is mounted on the vehicle 120 instead of the lighting device 123. In addition, a microphone MI is installed instead of the cameras 131 and 132.

As shown in FIG. 13, the microphone MI is installed in a width direction (a direction perpendicular to the direction of travel of the vehicle) of the road. In addition, as shown in FIG. 13, a plurality of microphones MI are installed to correspond to at least the entire billing allowable range. If it is necessary to detect the billing location even when the billing process has been performed outside the billing allowable range, microphones MI are additionally installed to correspond to the outside of the billing allowable range.

The speaker SP outputs a sound at a timing at which the on-vehicle device 121 performs the billing process, and at least one of the microphones MI acquires a sound from the speaker SP. The billing location detection unit 152 can detect the billing location based on a location at which the microphone MI that has acquired the loudest sound is installed. In this manner, the billing location detection unit 152 detects the billing location based on sound information from the speaker SP. The sound information here may be the presence or absence of a sound, or may be sound characteristics such as a sound pressure or a sound pressure distribution of a plurality of microphones.

Specifically, as described above, the billing location detection unit 152 specifies the microphone MI that has acquired the loudest sound based on acquisition of a sound output from the speaker SP or a magnitude (a sound pressure) of the acquired sound. Then, the billing location detection unit 152 detects a location of the speaker SP that outputs a sound based on the location of the detected microphone MI and thus detects the billing location. For example, the microphone MI and a location on the road according to the location of the microphone MI may be associated in advance, and the billing location detection unit may detect a location on the road associated with the microphone MI that has acquired the loudest sound as the billing location.

Furthermore, the billing location detection unit 152 may detect a distance between the speaker SP and the microphone MI and a relative location of the speaker SP with respect to the microphone MI based on a sound pressure of the sound acquired by the microphone MI or a sound pressure distribution of the plurality of microphones MI. The billing location detection unit 152 corrects the location on the road associated with the speaker SP based on a distance between the speaker SP and the microphone MI or a relative location of the speaker SP with respect to the microphone MI. Here, when the billing location detection unit 152 estimates a distance between the speaker SP and the microphone MI based on a sound pressure of the sound acquired by the microphone MI, the number of microphone MIs which are installed may be one.

Here, in order to detect the billing location with higher accuracy, it is desirable that at least either of the speaker SP or the microphone MI have directionality.

FIG. 14 is an explanatory diagram showing an example of a light receiving sensor array installation location when a laser beam is used as a signal. When a laser beam is used as a signal, a laser device LA instead of the lighting device 123 is mounted on the vehicle 120. The laser device here is a device configured to output a laser beam. In addition, instead of the cameras 131 and 132, light receiving sensors PS are installed. The light receiving sensor here is a sensor capable of detecting that light with a predetermined intensity or higher has been received.

As shown in FIG. 14, the laser device LA is installed in an orientation in which a laser beam is output in a width direction of the road. In addition, the light receiving sensor PS is installed in an orientation aligned with an orientation of a laser beam output from the laser device LA. As in the case of the microphone MI of FIG. 13, a plurality of light receiving sensors PS are installed along the road which is an example of a traveling path of the vehicle 120 to correspond to at least the entire billing allowable range. If it is necessary to detect the billing location also when the billing process has been performed outside the billing allowable range, as shown in FIG. 14, light receiving sensors PS are additionally installed to correspond to outside of the billing allowable range.

The laser device LA outputs a laser beam at a timing at which the on-vehicle device 121 perform the billing process. The group of the light receiving sensors PS corresponds to an example of the signal acquisition unit. Any of the light receiving sensors PS receives a laser beam from the laser device LA. The billing location detection unit 152 can detect the billing location based on (information on) which one light receiving sensor has received a laser beam first. In this manner, the billing location detection unit 152 detects the billing location based on the laser beam output from the laser device LA. More specifically, the billing location detection unit 152 specifies a light receiving sensor PS that has received a laser beam first, detects a location of the laser device LA that has output the laser beam based on the location of the specified light receiving sensor PS that has received the laser beam, and thus detects the billing location. For example, the light receiving sensor PS and a location on the road according to the location of the light receiving sensor PS may be associated in advance, and the billing location detection unit may detect a location on the road associated with the light receiving sensor PS that has acquired a laser beam first as the billing location (that is, detect the billing location based on a location of the light receiving sensor PS itself).

Further, a sensor capable of detecting a direction from which light is received may be used as the light receiving sensor PS, and the billing location detection unit 152 may detect a relative location of the billing location with respect to the light receiving sensor PS based on a direction from which the light receiving sensor PS receives light (first). Then, the billing location detection unit 152 may correct a location on the road associated with the light receiving sensor PS that has acquired light based on a relative location of the billing location with respect to the light receiving sensor PS and set the corrected location as the billing location (that is, detects the billing location based on both a location of the light receiving sensor PS itself and a relative location of the billing location with respect to the light receiving sensor PS).

Here, in order to prevent the light receiving sensor PS from being unable to receive a laser beam due to a difference between heights of the laser device LA and the light receiving sensor PS, the laser device LA may output a laser beam that is spread in the height direction as shown in FIG. 14.

Here, another device configured to output light with directionality instead of the laser device LA may be mounted on the vehicle 120. For example, a lighting device and a slit may be mounted on the vehicle 120 so that light output from the lighting device passes through the slit.

### Second Embodiment

### Configuration and Operations in Second Embodiment

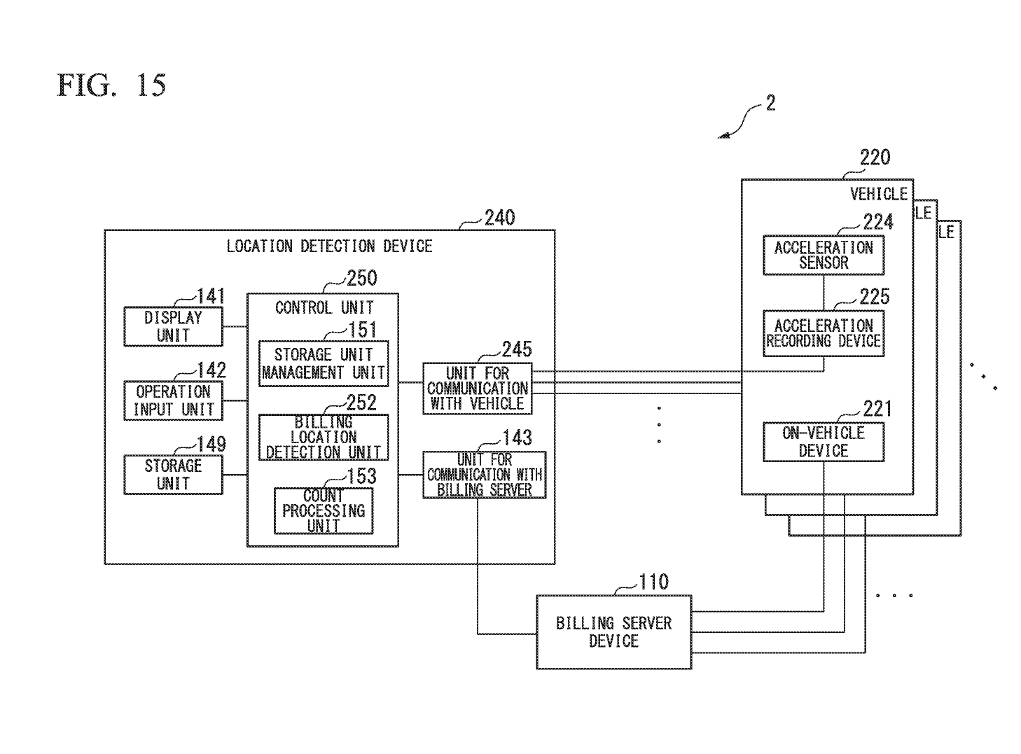

FIG. 15 is a schematic block diagram showing a functional configuration of an information presentation system for evaluating a billing location in a second embodiment of the present invention. In FIG. 15, an information presentation system for evaluating a billing location 2 includes the billing server device 110, a vehicle 220, and a location detection device 240. The vehicle 220 includes an on-vehicle device 221, an acceleration sensor 224, and an acceleration recording device 225. The location detection device 240 includes the display unit 141, the operation input unit 142, the unit for communication with a billing server 143, a unit for communication with a vehicle 245, and a control unit 250. The control unit 250 includes the storage unit management unit 151, a billing location detection unit 252, and the count processing unit 153. In FIG. 15, units having the same functions as the corresponding units in FIG. 1 are denoted with the same reference numerals 110, 141, 142, 143, 149, 151, and 153, and descriptions thereof will be omitted.

Like the information presentation system for evaluating a billing location 1, the information presentation system for evaluating a billing location 2 is a system for evaluating the accuracy of a billing location. On the other hand, the information presentation system for evaluating a billing location 2 is different from the information presentation system for evaluating a billing location 1 in that the billing location is detected based on an acceleration in the vehicle 220.

Like the vehicle 120, the vehicle 220 is a billing target vehicle that can travel on a road. On the other hand, devices which are installed in the vehicle 220 are different from those of the vehicle 120.

The on-vehicle device 221 is different from the on-vehicle device 121 in that it is not necessary for the on-vehicle device 121 to output a signal that is output to the signal output control device 122. Other functions of the on-vehicle device 221 are the same as those of the on-vehicle device 121. The on-vehicle device 221 corresponds to an example of a billing processing unit.

The acceleration sensor 224 measures an acceleration of the acceleration sensor 224 itself. The acceleration of the acceleration sensor 224 is used as an acceleration of the vehicle 220. The acceleration sensor 224 can measure an acceleration at least in a vertical direction. In particular, when the acceleration sensor 224 detects an acceleration or a change in acceleration, a force applied to the vehicle 220 due to a change in height of the surface provided at a predetermined location on the path on which the vehicle 220 is traveling is detected. The acceleration sensor 224 corresponds to an example of a force detection unit.

When the on-vehicle device 221 includes an acceleration sensor, the acceleration sensor may be used as the acceleration sensor 224. The on-vehicle device that performs the billing process based on location information includes an acceleration sensor in order to correct location information in many cases. When this acceleration sensor is used as the acceleration sensor 224, there is no need to separately provide an acceleration sensor in order to detect the billing location. Accordingly, it is possible to reduce costs and the size of the device.

The acceleration recording device 225 stores a history of acceleration detected by the acceleration sensor 224 in association with the time. In addition, the acceleration recording device 225 communicates with the unit for communication with a vehicle 245. In particular, the acceleration recording device 225 transmits the acceleration history to the unit for communication with a vehicle 245.

The location detection device 240 detects the billing location based on the acceleration measured by the acceleration sensor 224 and provides the detected information for evaluating the accuracy of the billing location. The location detection device 240 may detect whether the billing location is within the billing allowable range, and may detect a more detailed location. The location detection device 240 includes, for example, a computer.

The unit for communication with a vehicle 245 communicates with the acceleration recording device 225.

The control unit 250 has a specific process of detecting the billing location which is different from that of the control unit 150. The other functions of the control unit 250 are the same as those of the control unit 150. The control unit 250 is implemented, for example, when a CPU of the location detection device 240 reads and executes a program from the storage unit 149.

The billing location detection unit 252 detects a location at which the billing process has been performed based on a timing at which the on-vehicle device 221 performs the billing process and a timing at which the acceleration sensor 224 detects a force. The billing location detection unit 152 may detect whether the billing location is within the billing allowable range, and detect a more detailed location.

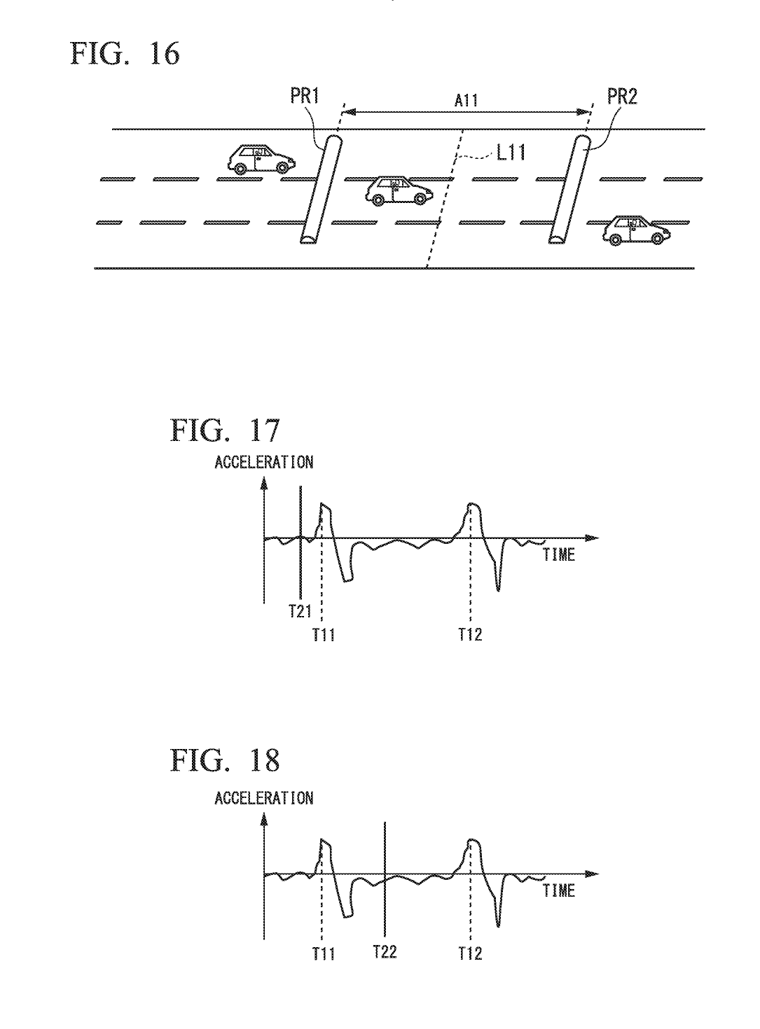

Next, a method of the billing location detection unit 252 detecting a billing location will be described with reference to FIGS. 16 to 19.

FIG. 16 is an explanatory diagram showing an example of a change in height provided on the surface of the road. In FIG. 16, the line L11 indicates the billing point, and the area A11 indicates a billing allowable range. The billing point and the billing allowable range are the same as those of the first embodiment. Here, the line L11 and the area A11 are illustrated only for description. There is no need to display the billing point and the billing allowable range on the road.

In FIG. 16, a protruding portion PR1 that is long in the width direction of the road is provided at the billing allowable range start position. When the vehicle 220 passes the protruding portion PR1, the acceleration sensor 224 detects a change in acceleration. A timing at which the vehicle 220 passes the billing allowable range start position is shown in the acceleration history stored by the acceleration recording device 225 according to the change in acceleration.

In addition, a protruding portion PR2 that is long in the width direction of the road is provided at the billing allowable range end position. When the vehicle 220 passes the protruding portion PR2, the acceleration sensor 224 detects a change in acceleration. A timing at which the vehicle 220 passes the billing allowable range end position is shown in the acceleration history stored by the acceleration recording device 225 according to the change in acceleration.

Here, the change in height of the surface of the road may be any difference due to which the acceleration sensor 224 can detect a change in acceleration, and is not limited to an unevenness on the surface such as a change in height due to a protruding portion. For example, a depressed portion may be provided on the surface of the road so that the height changes or a step may be provided on the surface of the road so that the height changes.

FIG. 17 is an explanatory diagram showing a first example of a relationship between a time at which an acceleration changes and a billing time. In the graph in FIG. 17, the horizontal axis represents the time and the vertical axis represents the acceleration. The graph shows a history of acceleration detected by the acceleration sensor 224. A time T11 shows an example of the billing allowable range start position passing time that is detected by the billing location detection unit 252 from the acceleration history. A time T12 shows an example of the billing allowable range end position passing time that is detected by the billing location detection unit 252 from the acceleration history.

In addition, a time T21 indicates an example of the billing time. Since the time T21 is earlier than the time T11, the billing location detection unit 252 determines that the on-vehicle device 221 has performed the billing process outside the billing allowable range.

In this manner, the billing location detection unit 252 acquires the history of acceleration measured by the acceleration sensor 224 from the acceleration recording device 225 through the unit for communication with a vehicle 245, and detects the billing allowable range start position passing time and the billing allowable range end position passing time. In addition, the billing location detection unit 252 acquires a billing time of the on-vehicle device 221 from the billing server device 110 through the unit for communication with a billing server 143.

Then, the billing location detection unit 252 determines whether the billing process has been performed within the billing allowable range according to the relation between the billing allowable range start position passing time, the billing allowable range end position passing time, and the billing time, and acquires the determination result as the billing location. Specifically, when the billing time is located between the billing allowable range start position passing time and the billing allowable range end position passing time, the billing location detection unit 252 determines that the billing process has been performed within the billing allowable range. On the other hand, when the billing time is earlier than the billing allowable range start position passing time or when the billing time is later than the billing allowable range end position passing time, the billing location detection unit 252 determines that the billing process has not been performed within the billing allowable range.

FIG. 18 is an explanatory diagram showing a second example of a relationship between a time at which an acceleration changes and a billing time. In FIG. 18, the acceleration graph, and the times T11 and T12 are the same as those in FIG. 17. On the other hand, the example in FIG. 18 is different from the example in FIG. 17 in that a time T22 indicating a billing time is located between the time T11 and the time T12.

In the example in FIG. 18, the billing location detection unit 252 determines that the on-vehicle device 221 has performed the billing process within the billing allowable range.

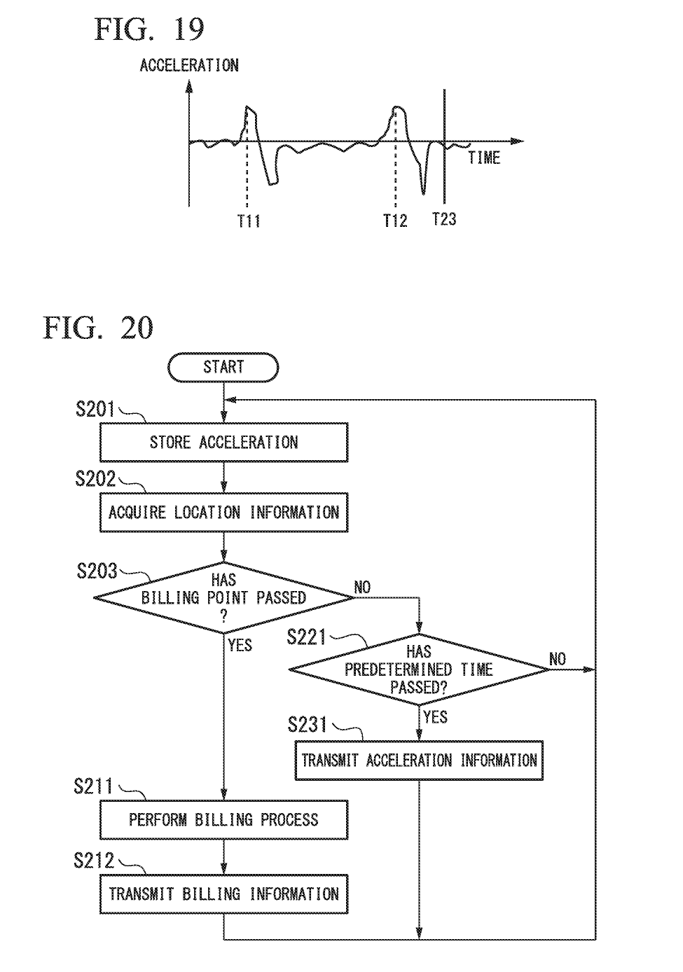

FIG. 19 is an explanatory diagram showing a third example of a relationship between a time at which an acceleration changes and a billing time. In FIG. 19, the acceleration graph and the times T11 and T12 are the same as those in FIG. 17. On the other hand, the example in FIG. 19 is different from the example in FIG. 17 in that a time T23 indicating a billing time is later than the time T12.

In the example in FIG. 19, the billing location detection unit 252 determines that the on-vehicle device 221 has performed the billing process outside the billing allowable range.

Here, like the billing location detection unit 152, the billing location detection unit 252 may obtain a more detailed lighting start position.

Specifically, the billing location detection unit 252 obtains the ratio between a time from when the billing allowable range start position has passed until the billing process has been performed and a time from when the billing process has been performed until the billing allowable range end position has passed. Then, the billing location detection unit 252 determines that the billing process has been performed at a location of progression according to the obtained ratio within the entire billing allowable range and calculates the billing location. Accordingly, the billing location detection unit 252 obtains the billing location when the vehicle 220 travels within the billing allowable range at almost a constant speed in a more detailed manner.

### Operations in Second Embodiment

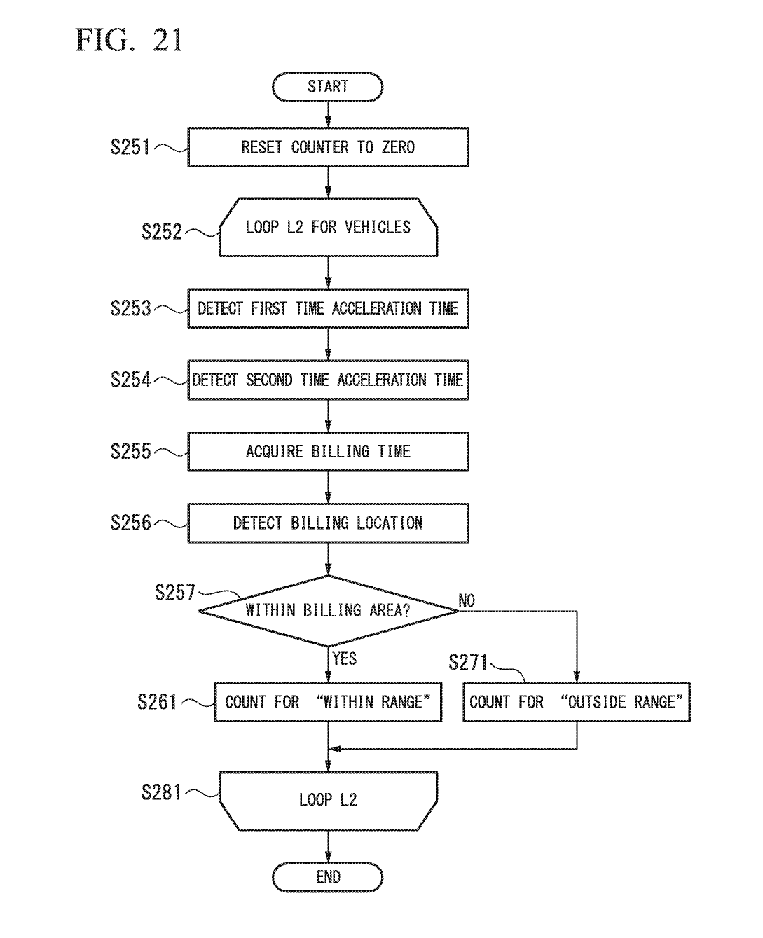

Next, operations of the information presentation system for evaluating a billing location 2 will be described with reference to FIGS. 20 and 21.

FIG. 20 is a flowchart showing an example of a processing procedure performed by a device mounted on the vehicle 220. The on-vehicle device 221, the acceleration sensor 224, and the acceleration recording device 225 start the process in FIG. 20, for example, when their own power sources are turned on and they are activated.

In the process in FIG. 20, the acceleration recording device 225 stores the acceleration measured by the acceleration sensor 224 in association with the time (Step S201).

Steps S202 to S203 are the same as Steps S101 to S102 in FIG. 7. In Step S203, when it is determined that a vehicle 220 has passed the billing point and the billing process has not been performed during the passing (YES in Step S203), the process advances to Step S211.

Steps S211 to S212 are the same as Steps S112 to S113 in FIG. 7. After Step S212, the process advances to Step S201.

On the other hand, in Step S203, when it is determined that no vehicles 220 have passed the billing point or the billing process has not been performed (NO in Step S203), the acceleration recording device 225 determines whether an untransmitted acceleration history has been accumulated for a predetermined time (Step S221).

When it is determined that an untransmitted acceleration history has not accumulated for a predetermined time (NO in Step S221), the process returns to Step S201.

On the other hand, when it is determined that an untransmitted acceleration history has accumulated for a predetermined time (YES in Step S221), the acceleration recording device 225 transmits the untransmitted acceleration history to the unit for communication with a vehicle 245 (Step S231). After Step S231, the process returns to Step S201.

FIG. 21 is a flowchart showing an example of a processing procedure in which the control unit 250 generates information for evaluating the accuracy of the billing location. For example, when a user operation instructing generation of the information is performed, the control unit 250 starts the process in FIG. 21.

In the process in FIG. 21, the control unit 250 performs the processes of Steps S253 to S256 instead of the processes of Steps S153 to S154 in FIG. 8. In addition, in the loop L1 in FIG. 8, the control unit 150 performs processing on each of the vehicles 120 imaged by the cameras 131 and 132. However, in a loop L2 in FIG. 21, the control unit 250 performs processing on each of the vehicles 220 whose acceleration histories are acquired by the unit for communication with a vehicle 245 from the acceleration recording device 225. Otherwise the processes are the same as those in FIG. 8.

In Step S253, the billing location detection unit 252 detects the first time at which an acceleration changes to a predetermined magnitude or more from the acceleration history of the target vehicle obtained from the acceleration recording device 225, as exemplified by the time T11 in FIG. 17.

In Step S254, the billing location detection unit 252 detects the second time at which an acceleration changes to a predetermined magnitude or more from the acceleration history of the target vehicle from the acceleration recording device 225 as exemplified by the time T12 in FIG. 17.

Here, detection of the first time and the second time at which an acceleration changes to a predetermined magnitude or more in Steps S253 and S254 may be automatically performed by the billing location detection unit 252 or may be performed upon reception of a user operation.

In Step S255, the billing location detection unit 252 detects a billing time of the target vehicle from billing information. For example, the acceleration recording device 225 transmits an on-vehicle device ID together with the acceleration history to the unit for communication with a vehicle 245, and the billing location detection unit 252 acquires a billing time that is associated with the on-vehicle device ID in the billing information.

In Step S256, it is determined whether a location of the target vehicle is within the billing allowable range using the method described with reference to FIGS. 17 to 19 and the determination result is acquired as billing location information.

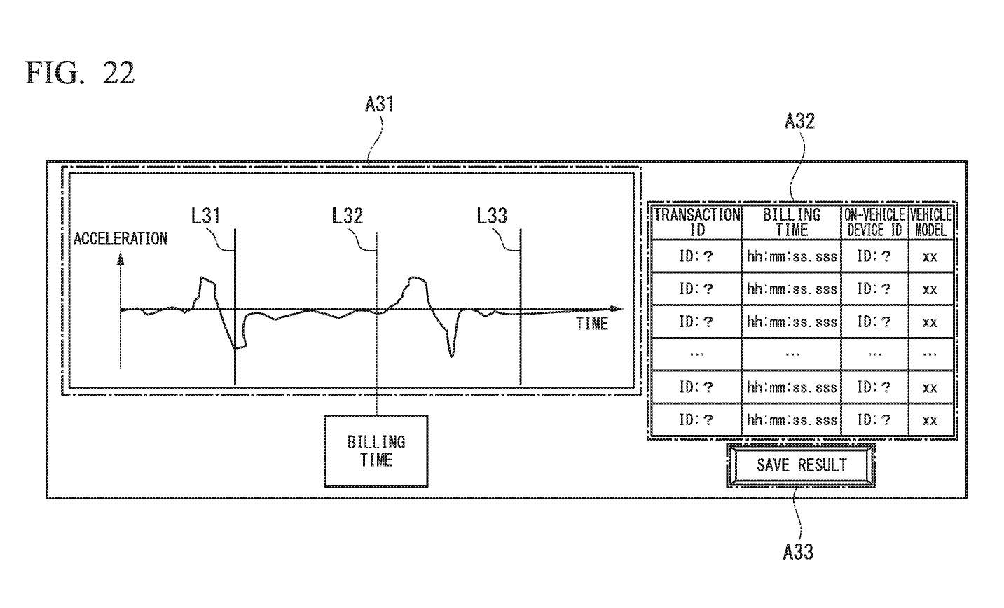

Next, the processes in which the billing location detection unit 252 receives a user operation and detects a billing location will be described with reference to FIGS. 22 to 25. The billing location detection unit 252 performs, for example, the following processes as the processes of Steps S253 to S256 in FIG. 21.

FIG. 22 is an explanatory diagram showing an example of a screen displayed on the display unit 141 in order to detect the billing location.

In the example of FIG. 22, the display unit 141 displays the graph of the acceleration history on an area A31. In the graph of the area A31, the horizontal axis represents the time and the vertical axis represents the acceleration.

In addition, the display unit 141 displays billing information on an area A32. The display unit 141 displays billing information in a table format, one row shows information about one instance of billing, and items included in each row are the same as those in FIG. 9.

In addition, the display unit 141 displays an operation button for instructing the result of the process to be saved on an area A33.

One row is selected from the billing information shown in the area A32. An acceleration history corresponding to the selected row is shown in the area A31. Lines L31 to L33 are shown in the area A31.

The line L32 indicates a billing time. In addition, the line L31 indicates an estimated time at which the billing allowable range start position has passed. The line L33 indicates an estimated time at which the billing allowable range end position has passed. The lines L31 and L33 are displayed as references and are not essential.

For example, the billing location detection unit 252 acquires speed information of the vehicle 220 at the billing point. Then, the billing location detection unit 252 divides a distance from the billing allowable range start position to the billing point by the speed and calculates a time required from the billing allowable range start position to the billing point. Then, the billing location detection unit 252 subtracts the obtained required time from the billing time and sets it as an estimated time at which the billing allowable range start position has passed.

Similarly, the billing location detection unit 252 divides a distance from the billing point to the billing allowable range end position by the speed and calculates a time required from the billing point to the billing allowable range end position. Then, the billing location detection unit 252 adds the billing time to the obtained required time and sets it as an estimated time at which the billing allowable range end position has passed.

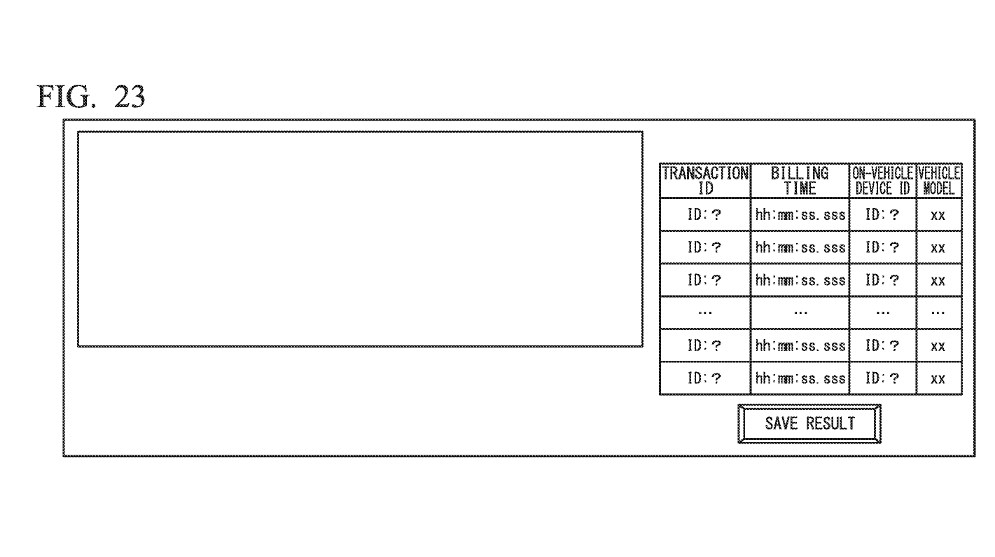

FIG. 23 is an explanatory diagram showing an example of a screen displayed on the display unit 141 before a row in billing information is selected. In FIG. 23, the display unit 141 displays billing information but does not display an acceleration history.

In the state in FIG. 23, the user selects any row in the billing information.

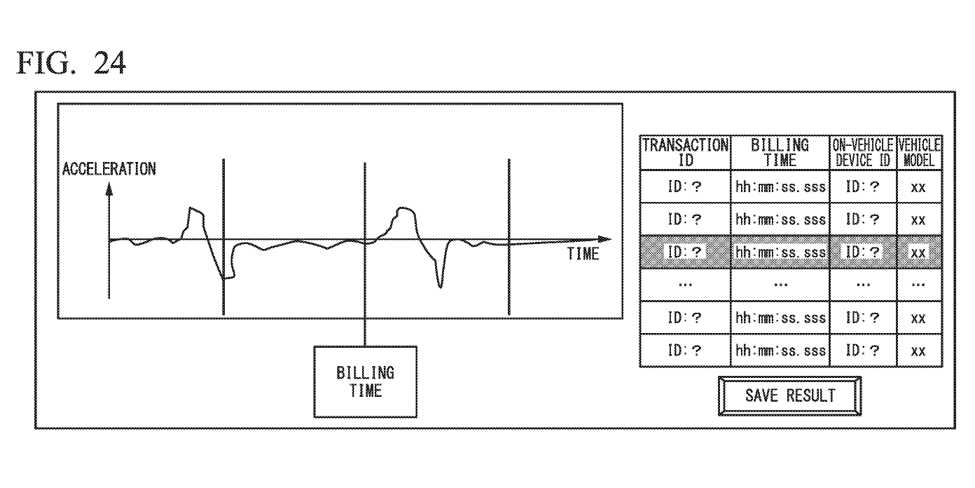

FIG. 24 is an explanatory diagram showing an example of a screen displayed on the display unit 141 after a row in billing information is selected. In FIG. 24, the display unit 141 displays an acceleration history corresponding to the selected row.

In the state in FIG. 24, the user selects the billing allowable range start position passing time and the billing allowable range end position passing time on the graph. For example, the user selects a time at which the magnitude of the change in acceleration is a maximum as the billing allowable range start position passing time and the billing allowable range end position passing time.

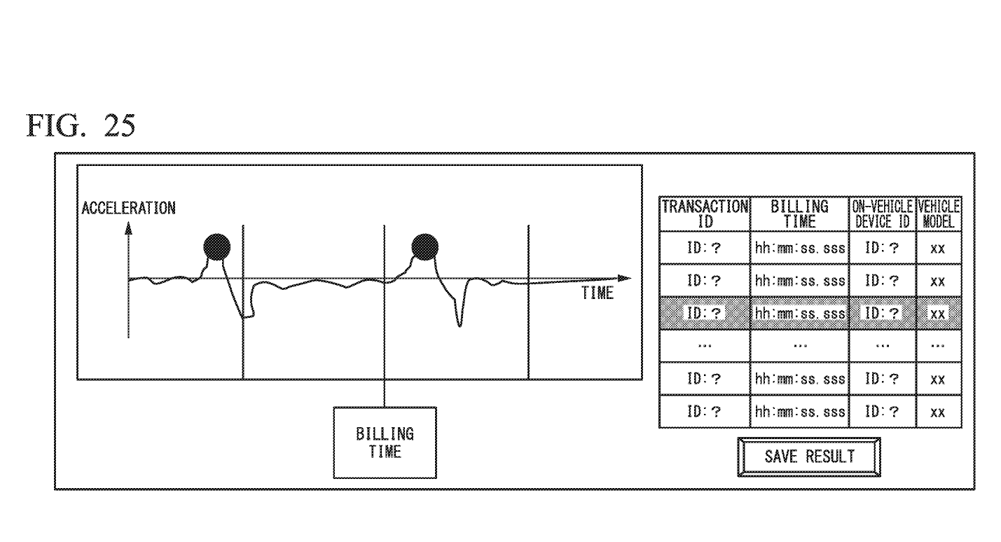

FIG. 25 is an explanatory diagram showing an example of a screen displayed on the display unit 141 after the billing allowable range start position passing time and the billing allowable range end position passing time are selected. In FIG. 25, the display unit 141 displays the selected time with a mark on the graph. Accordingly, the user can confirm that selection is performed correctly and it is possible to reduce errors in operation.

When selecting the billing allowable range start position passing time and the billing allowable range end position passing time have been completed, the user presses a result save button (for example, clicks a mouse) to confirm the selection.

According to the user operation, the billing allowable range start position passing time, the billing allowable range end position passing time, and the billing time are confirmed. The billing location detection unit 252 determines whether a location of the target vehicle is within the billing allowable range using the method described with reference to FIGS. 17 to 19 and acquires the determination result as billing location information.

The process (here, one process of Steps S253 to S256) for one vehicle 220 has been completed above.

Further, similarly, the processes of Steps S253 to S256 are performed on another target vehicle in the loop L2.

As described above, the acceleration sensor 224 detects a force applied to the vehicle 220 due to a change in height of the surface provided at a predetermined location on the road. Then, the billing location detection unit 252 detects a location at which the billing process has been performed based on a timing at which the on-vehicle device 221 has performed the billing process and a timing at which the acceleration sensor 224 detects the force applied.

Accordingly, in the information presentation system for evaluating a billing location 2, it is possible to provide information for evaluating a billing location at relatively low cost without an expensive device such as a high accuracy location determining device.

In addition, in the information presentation system for evaluating a billing location 2, there is no need to perform special adjustment for a device to be mounted on the vehicle 220. In particular, even when the billing location is evaluated for a plurality of vehicles, the burden on an operator who installs the device in the vehicles 220 is relatively small.

In addition, the acceleration sensor 224 detects a force applied to the vehicle 220 when traveling due to a change in height of the surface provided at two places on the path along which the vehicle 220 travels. Then, the billing location detection unit 152 detects whether the billing location is included within the range having the two places as two ends thereof.

Accordingly, the billing location detection unit 152 can detect the billing location according to a simple operation of determining the relation between a timing at which the acceleration sensor 224 detects a force applied and the billing time.

In addition, the acceleration sensor 224 detects a force applied to the vehicle 220 when traveling due to a change in height of the surface that is additionally provided between the two places. The billing location detection unit 152 may detect a section in which a location at which the billing process has been performed is included among sections of the path along which the vehicle 220 travels that are separated by a change in height of the surface.

Accordingly, the billing location detection unit 152 can detect a location at which the billing process has been performed in a more detailed manner

Here, the acceleration recording device 225 may store the acceleration history only in the vicinity of the billing allowable range. For example, the acceleration recording device 225 may store the acceleration history only when location information is acquired from the on-vehicle device 221 and it is determined that the location is within a predetermined distance from the billing allowable range.

Accordingly, it is possible to reduce the amount of data stored by the acceleration recording device 225 and it is possible to reduce a storage capacity of the acceleration recording device 225. In addition, since the data size of the acceleration history is reduced, the burden of the billing location detection unit 252 detecting the billing allowable range start position passing time and the billing allowable range end position passing time from the acceleration history is reduced.

Here, when a first vibration is detected, an estimate of the time until a second vibration will occur may be calculated based on the speed of the on-vehicle device 221, and the acceleration recording device 225 may store the acceleration history only in the vicinity of the obtained estimated time.

Accordingly, it is possible to further reduce the amount of data stored by the acceleration recording device 225 and it is possible to further reduce a storage capacity of the acceleration recording device 225. In addition, since the data size of the acceleration history is further reduced, the burden of the billing location detection unit 252 detecting the billing allowable range start position passing time and the billing allowable range end position passing time from the acceleration history is further reduced.

Alternatively, the acceleration recording device 225 may store information about a time at which a change in acceleration of a predetermined magnitude or more is detected instead of the acceleration history.

Here, a threshold value when the billing location detection unit 252 or the acceleration recording device 225 detects a change in acceleration of a predetermined magnitude or more may be selected according to the vehicle model of the vehicle 220.

For example, when the vehicle 220 is a large vehicle, it is considered that it will vibrate less compared to when the vehicle 220 is a small vehicle. Therefore, when the vehicle 220 is a large vehicle, the billing location detection unit 252 uses a smaller threshold value than when the vehicle 220 is a small vehicle. Accordingly, the billing location detection unit 252 can detect a timing at which the acceleration greatly changes more accurately.

### Modification of Second Embodiment

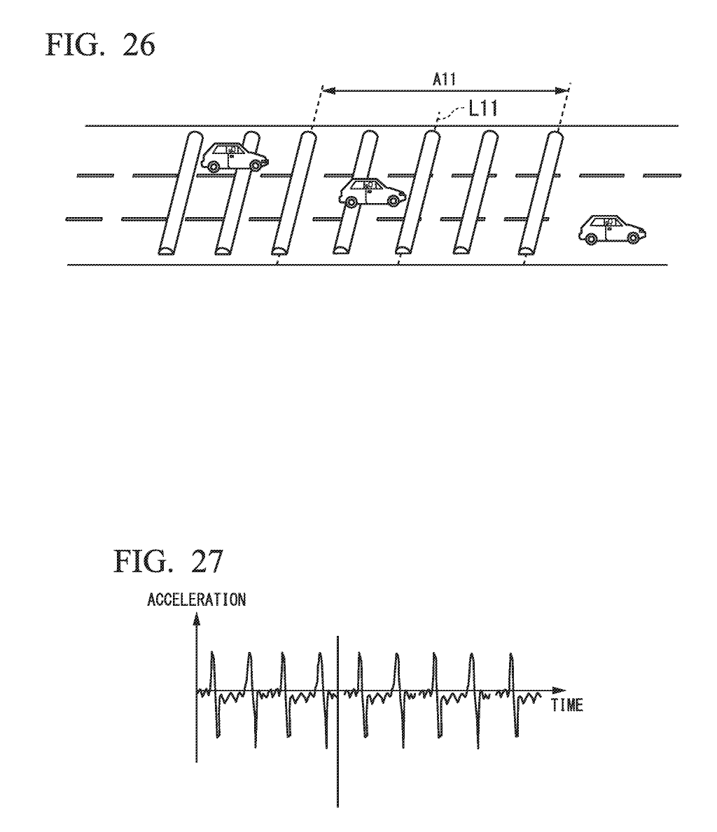

The number of places in which a height of a surface changes on the road is not limited to two as exemplified in FIG. 16. This will be described with reference to FIGS. 26 and 27.

FIG. 26 is an explanatory diagram showing an example of a road in which a height of a surface changes at three or more places. In the example in FIG. 26, in addition to the billing allowable range start position and the billing allowable range end position, three places are provided within the billing allowable range and four places are provided outside the billing allowable range. Accordingly, in the example in FIG. 26, a height of a surface changes in nine places arranged at equal intervals.

FIG. 27 is an explanatory diagram showing an example of an acceleration history when a change in surface height is provided at three or more places in a road. In the graph in FIG. 27, the horizontal axis represents the time, and the vertical axis represents the acceleration.

FIG. 27 shows an example of an acceleration when the vehicle 220 travels along the road shown in FIG. 26. According to the change in height of the surface at the nine places in FIG. 26, there are nine timings at which the acceleration greatly changes in FIG. 27. When a location of a billing time among the nine timings is determined, the billing location detection unit 252 can detect the billing location in a more detailed manner

### Third Embodiment

### Configuration and Operations in Second Embodiment

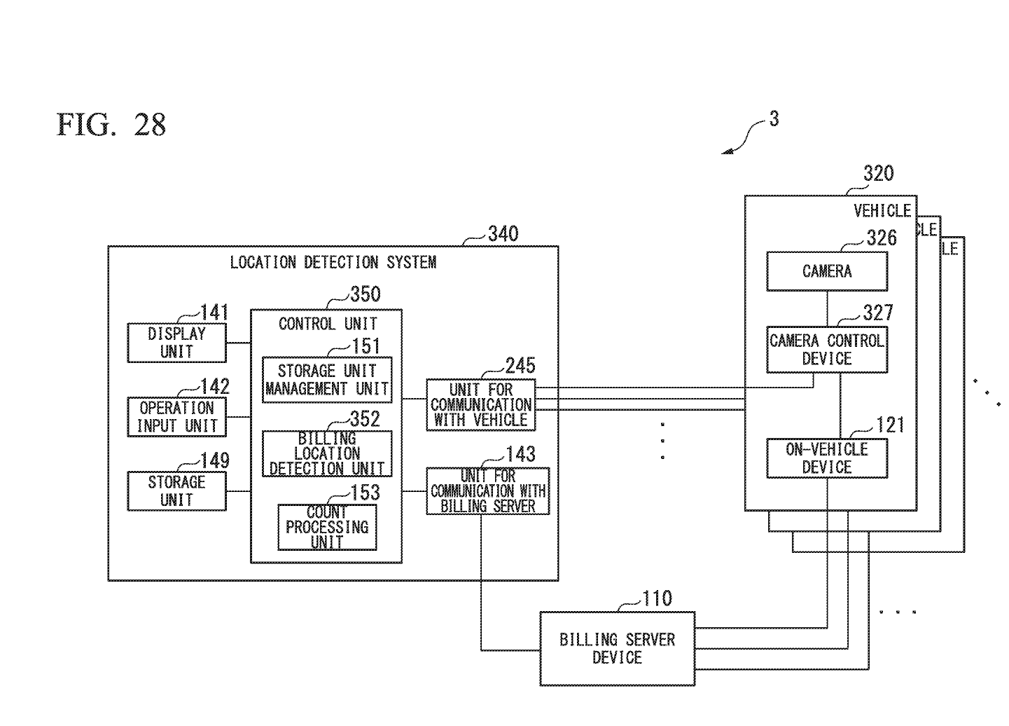

FIG. 28 is a schematic block diagram showing a functional configuration of an information presentation system for evaluating a billing location in a third embodiment of the present invention. In FIG. 28, an information presentation system for evaluating a billing location 3 includes the billing server device 110, a vehicle 320, and a location detection device 340. The vehicle 320 includes the on-vehicle device 221, a camera 326, and a camera control device 327. The location detection device 340 includes the display unit 141, the operation input unit 142, the unit for communication with a billing server 143, the unit for communication with a vehicle 245, and a control unit 350. The control unit 350 includes the storage unit management unit 151, a billing location detection unit 352, and the count processing unit 153. In FIG. 28, units having the same functions as the corresponding units in FIG. 1 or FIG. 15 are denoted with the same reference numerals 110, 141, 142, 143, 149, 151, 153, 221, and 245, and descriptions thereof will be omitted.

Like the information presentation system for evaluating a billing location 1, the information presentation system for evaluating a billing location 3 is a system for evaluating the accuracy of a billing location. On the other hand, the information presentation system for evaluating a billing location 3 is different from the information presentation system for evaluating a billing location 1 in that the billing location is detected based on the image captured from the vehicle 320.

The vehicle 320 is a billing target vehicle that can travel on a road, like the vehicle 120. On the other hand, devices which are installed in the vehicle 320 are different from those of the vehicle 120.

The camera 326 is mounted on the vehicle 320, and images the outside from the vehicle 320 at a timing at which the billing process has been performed based on a location of the vehicle 320. The camera 326 corresponds to an example of an imaging unit. The camera 326 is installed at a right angle to the direction of travel of the vehicle 320 and captures an image corresponding to the location of the vehicle 320.

The camera control device 327 controls the camera 326. In particular, when a signal indicating execution of the billing process is acquired from the on-vehicle device 121, the camera control device 327 causes the camera 326 to capture an image. Like the signal output control device 122, in order to connect the camera control device 327 and the on-vehicle device 121, it is conceivable to use a part that is generally provided in the on-vehicle device 121.

In addition, the camera control device 327 transmits the image captured by the camera 326 to the unit for communication with a vehicle 245 as image data.

The control unit 350 has a specific process of detecting a billing location that is different from that of the control unit 150. The other functions of the control unit 350 are the same as those of the control unit 150. The control unit 350 is implemented, for example, when a CPU of the location detection device 340 reads and executes a program from the storage unit 149.

The billing location detection unit 352 detects a location at which the billing process has been performed based on the image captured by the camera 326. The billing location detection unit 352 may detect whether the billing location is within the billing allowable range and detect a more detailed location.

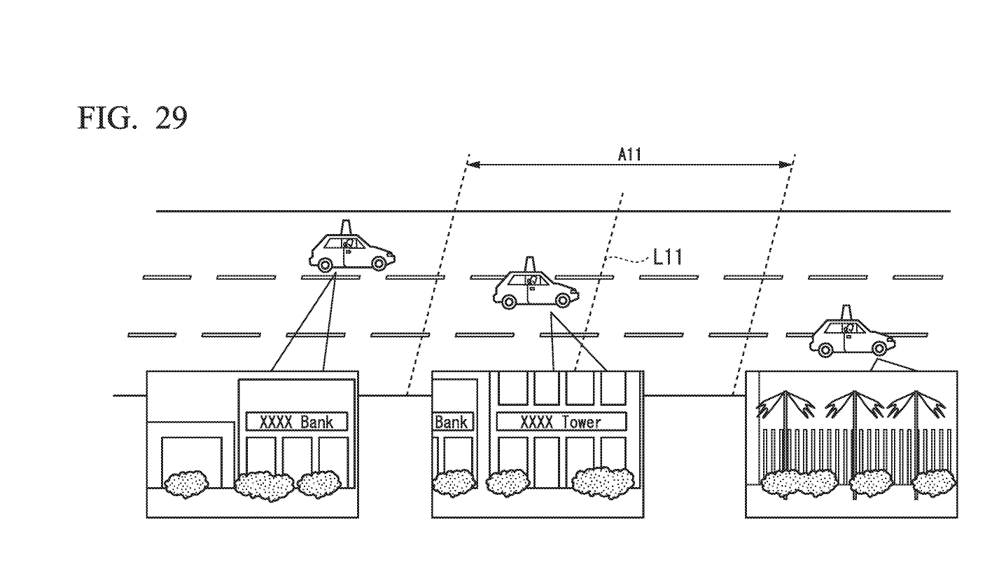

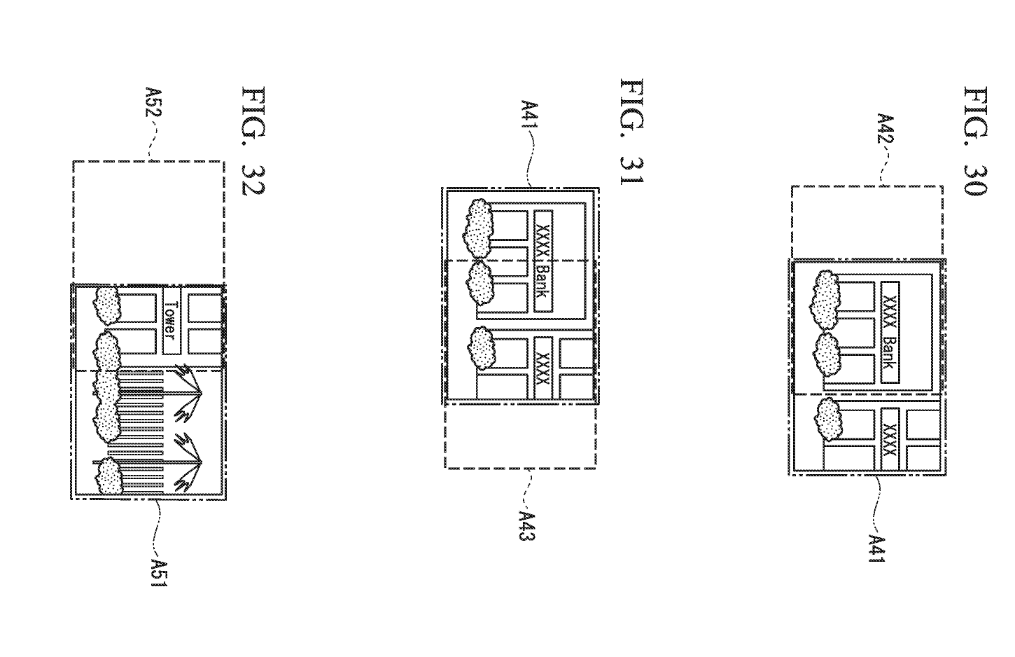

Next, a method of detecting a billing location performed by the billing location detection unit 352 will be described with reference to FIGS. 29 to 33.

FIG. 29 is an explanatory diagram showing an example of the image captured by the camera 326. In FIG. 29, the line L11 indicates the billing point, and the area A11 indicates a billing allowable range. The billing point and the billing allowable range are the same as those of the first embodiment. Here, the line L11 and the area A11 are illustrated only for description. There is no need to display the billing point and the billing allowable range on the road.

As shown in FIG. 29, the camera 326 captures different images according to a location of the vehicle 320. Therefore, the billing location detection unit 352 can detect the billing location based on the image captured by the camera 326.

For example, the storage unit 149 stores the image captured from the billing allowable range start position and the image captured from the billing allowable range end position in advance, and the billing location detection unit 352 compares these images with the image captured by the camera 326 and detects the billing location. In this case, the billing location detection unit 352 may perform processing on the image captured by the camera 326 in real time, and the storage unit 149 may temporarily store the image captured from the billing allowable range start position and the image captured from the billing allowable range end position.

In addition, in consideration of the fact that it is possible to detect the billing location based on the image captured by the camera 326, the image corresponds to an example of information for evaluating a location at which the billing process has been performed.

FIG. 30 is an explanatory diagram showing a first example of a positional relationship when the image captured from the billing allowable range start position and the image captured by the camera 326 are superimposed.

In FIG. 30, the image captured from the billing allowable range start position is displayed on an area A41. In addition, an area A42 shows a location of the image captured by the camera 326 when the image captured by the camera 326 is superimposed on the image captured from the billing allowable range start position.

In the example in FIG. 30, the image captured by the camera 326 is arranged to be shifted to the left side with respect to the image captured from the billing allowable range start position.

Here, in the example in FIG. 30, the camera 326 performs imaging in a left side direction with respect to the direction of travel of the vehicle 320. Therefore, it can be determined that the camera 326 has performed imaging from a location (outside the billing allowable range) before the billing allowable range start position.

FIG. 31 is an explanatory diagram showing a second example of a positional relationship when the image captured from the billing allowable range start position and the image captured by the camera 326 are superimposed.

In FIG. 31, as in the case in FIG. 30, the image captured from the billing allowable range start position is displayed on the area A41. In addition, an area A43 shows a location of the image captured by the camera 326 when the image captured by the camera 326 is superimposed on the image captured from the billing allowable range start position.

In the example in FIG. 31, the image captured by the camera 326 is arranged to be shifted to the right side with respect to the image captured from the billing allowable range start position.

As in the case in FIG. 30, in the example in FIG. 31, the camera 326 performs imaging in a left side direction with respect to the direction of travel of the vehicle 320. Therefore, it can be determined that the camera 326 has performed imaging from a location (within the billing allowable range) after progression from the billing allowable range start position.

FIG. 32 is an explanatory diagram showing a first example of a positional relationship when the image captured from the billing allowable range end position and the image captured by the camera 326 are superimposed.

In FIG. 32, the image captured from the billing allowable range end position is displayed on an area A51. In addition, an area A52 shows a location of the image captured by the camera 326 when the image captured by the camera 326 is superimposed on the image captured from the billing allowable range end position.

In the example in FIG. 32, the image captured by the camera 326 is arranged to be shifted to the left side with respect to the image captured from the billing allowable range start position.

As in the case in FIG. 30, in the example in FIG. 32, the camera 326 performs imaging in a left side direction with respect to the direction of travel of the vehicle 320.

Therefore, it can be determined that the camera 326 has performed imaging from a location (within the billing allowable range) before the billing allowable range end position.

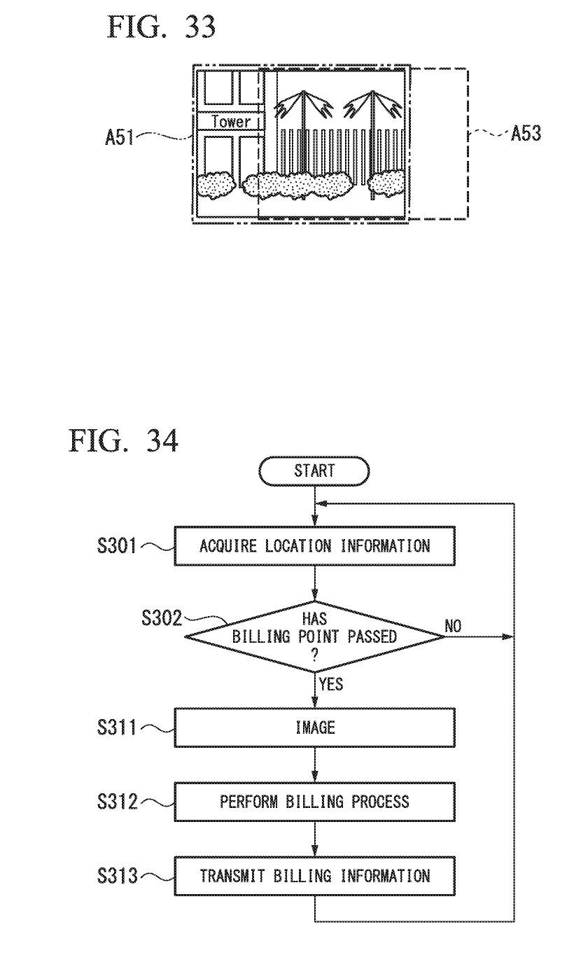

FIG. 33 is an explanatory diagram showing a second example of a positional relationship when the image captured from the billing allowable range end position and the image captured by the camera 326 are superimposed.

In FIG. 33, as in the case of FIG. 32, the image captured from the billing allowable range end position is displayed on the area A51. In addition, an area A53 shows a location of the image captured by the camera 326 when the image captured by the camera 326 is superimposed on the image captured from the billing allowable range end position.

In the example in FIG. 33, the image captured by the camera 326 is arranged to be shifted to the right side with respect to the image captured from the billing allowable range end position.

As in the case in FIG. 30, in the example in FIG. 33, the camera 326 performs imaging in a left side direction with respect to the direction of travel of the vehicle 320. Therefore, it can be determined that the camera 326 has performed imaging from a location (outside the billing allowable range) after progression from the billing allowable range end position.

In this manner, the billing location detection unit 352 detects the billing location based on a positional relationship between images when the image captured by the camera 326 and the image captured from the billing allowable range start position or the image captured from the billing allowable range end position are superimposed.

### Operation in Third Embodiment

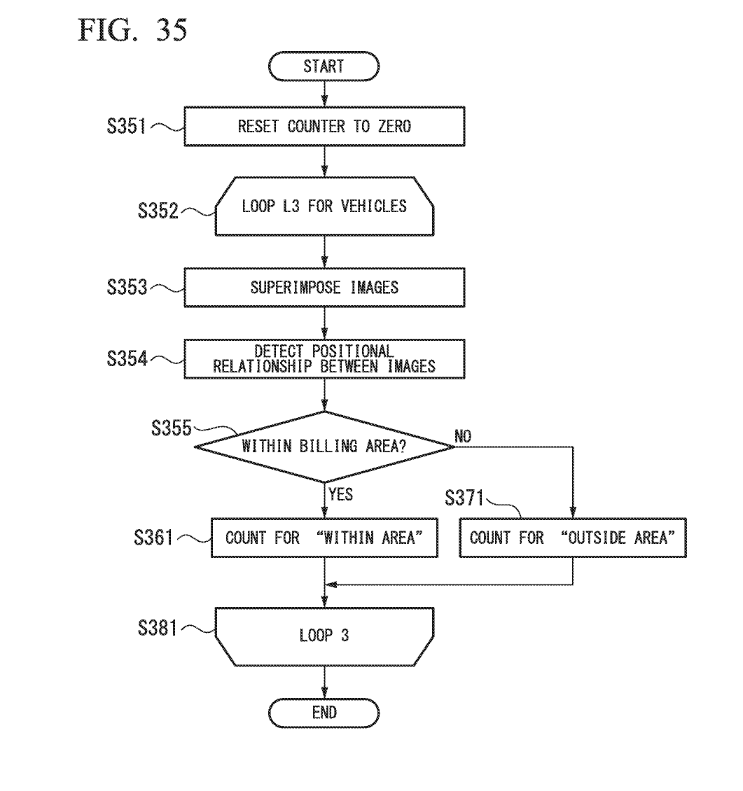

Next, operations of the information presentation system for evaluating a billing location 3 will be described with reference to FIGS. 34 and 35.

FIG. 34 is a flowchart showing an example of a processing procedure performed by a device mounted on the vehicle 320. The on-vehicle device 121, the camera 326, and the camera control device 327 start the process in FIG. 34, for example, when their own power sources are turned on and they are activated.

In the process of FIG. 34, the on-vehicle device 121, the camera 326, and the camera control device 327 perform the process of Step S311 instead of the process of Step S111 in FIG. 7. Otherwise the processes are the same as those in FIG. 7.

In Step S311, the on-vehicle device 121 outputs a signal indicating execution of the billing process to the camera control device 327, and the camera 326 performs imaging under control of the camera control device 327.

FIG. 35 is a flowchart showing an example of a processing procedure in which the control unit 350 generates information for evaluating the accuracy of the billing location. For example, the control unit 350 starts the process in FIG. 35 when a user operation instructing generation of the information is performed.

In the process in FIG. 35, the control unit 350 performs the processes of Steps S353 to S354 instead of the processes of Steps S153 to S154 in FIG. 8. In addition, in the loop L1 in FIG. 8, the control unit 150 performs processing on each of the vehicles 120 imaged by the cameras 131 and 132. However, in a loop L3 in FIG. 35, the control unit 350 performs processing on each of the vehicles 320 whose images are acquired from the camera control device 327 by the unit for communication with a vehicle 245. Otherwise the processes are the same as those in FIG. 8.

In Step S353, the image captured by the camera 326 and the image of the billing allowable range start position or the image of the billing allowable range end position are superimposed by the billing location detection unit 352. The image superimposition in Step S353 may be automatically performed by the billing location detection unit 352 or may be performed upon reception of a user operation.

When the image superimposition is automatically performed, the billing location detection unit 352 extracts feature points from two superimposed images, matches the feature points, and detects a positional relationship between the images. For a matching process, the billing location detection unit 352 can use an algorithm having universality for a magnitude and brightness, for example, a scale-invariant feature transform (SIFT).

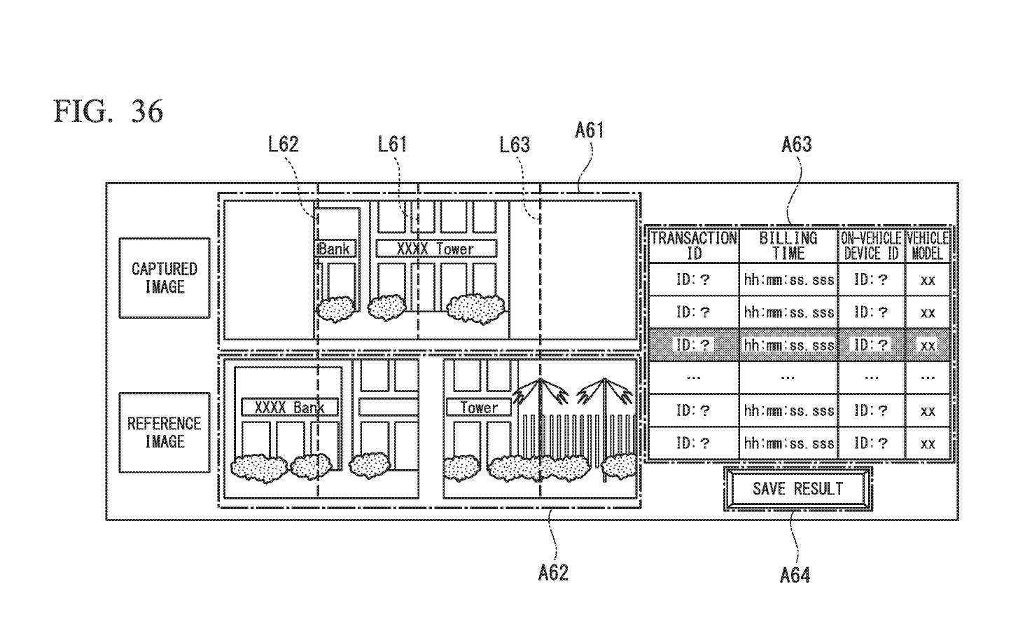

Next, the processes in which the billing location detection unit 352 receives a user operation and detects a billing location will be described with reference to FIGS. 36 to 39. The billing location detection unit 352 performs, for example, the following processes, as the processes of Steps S353 to S354 in FIG. 35.

FIG. 36 is an explanatory diagram showing an example of a screen displayed on the display unit 141 in order to detect the billing location.

In the example in FIG. 36, the display unit 141 displays the image captured by the camera 326 on an area A61. In addition, the display unit 141 displays the image captured from the billing allowable range start position and the image captured from the billing allowable range end position on an area A62.

In addition, the display unit 141 displays billing information on an area A63. The display unit 141 displays billing information in a table format, one row shows information about one instance of billing, and items included in each row are the same as those in FIG. 9.

In addition, the display unit 141 displays an operation button for instructing the result of the process to be saved on an area A64.

One row is selected from the billing information shown in the area A63. An image corresponding to the selected row is shown in the area A61.

The image displayed in the area A61 can be moved to the left and right according to a user operation, for example, a mouse dragging operation. Accordingly, the user can align the image captured by the camera 326 and the image captured from the billing allowable range start position or the image captured from the billing allowable range end position. According to this aligning, like the image superimposition, it is possible to determine a positional relationship between the image captured by the camera 326 and the image captured from the billing allowable range start position or the image captured from the billing allowable range end position.

In addition, a line L61 indicates the center of the image captured by the camera 326. In addition, a line L62 indicates the center of the image captured from the billing allowable range start position. A line L63 indicates the center of the image captured from the billing allowable range end position. However, these lines are not essential. On the other hand, when the display unit 141 displays these lines, the user can determine a positional relationship between images more accurately.

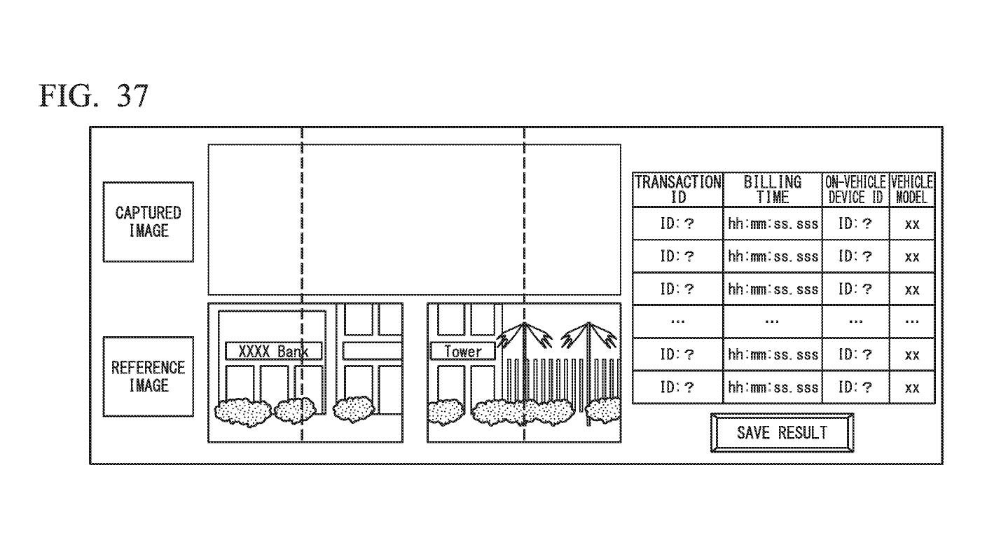

FIG. 37 is an explanatory diagram showing an example of a screen displayed on the display unit 141 before a row in billing information is selected. In FIG. 37, the display unit 141 displays the billing information, the image captured from the billing allowable range start position, and the image captured from the billing allowable range end position, but does not display the image captured by the camera 326.

In the state of FIG. 37, the user selects any row in the billing information.

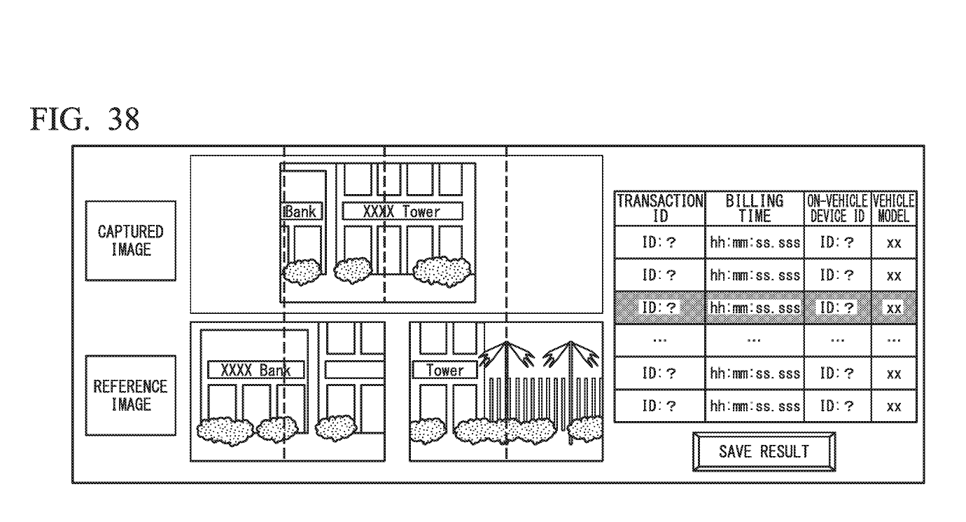

FIG. 38 is an explanatory diagram showing an example of a screen displayed on the display unit 141 after a row in billing information is selected. In FIG. 38, the display unit 141 displays the image captured by the camera 326 corresponding to the selected row.

In the state of FIG. 38, the user moves the image captured by the camera 326 to the left and right and aligns the image captured from the billing allowable range start position or the image captured from the billing allowable range end position.

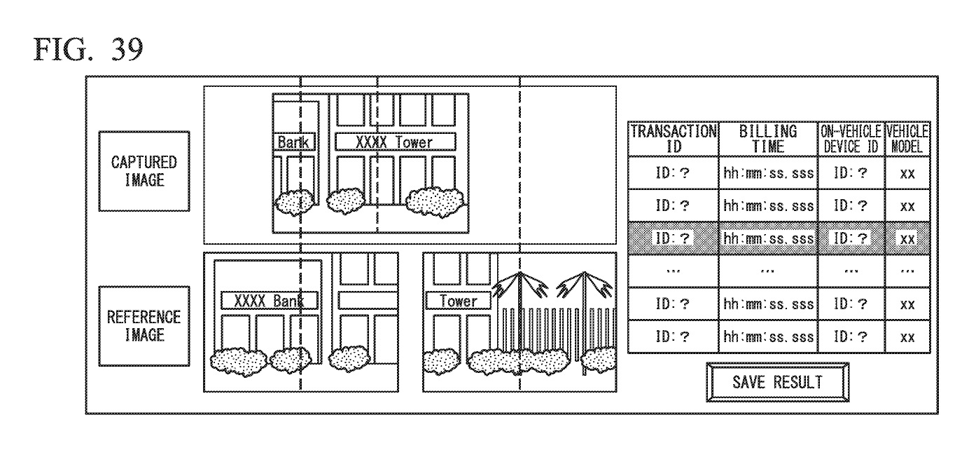

FIG. 39 is an explanatory diagram showing an example of a screen displayed on the display unit 141 after the image captured by the camera 326 and the image captured from the billing allowable range start position or the image captured from the billing allowable range end position are aligned. In FIG. 39, the image captured by the camera 326 and the image captured from the billing allowable range start position are aligned.

Specifically, as shown in FIG. 39, an image of the same building is included in the image captured by the camera 326 and the image captured from the billing allowable range start position. Then, a location of the image of the building in the horizontal direction is aligned between the image captured by the camera 326 displayed on the upper side and the image captured from the billing allowable range start position displayed on the lower side.

When image alignment is completed, the user presses a result save button (for example, clicks a mouse) to conform the selection.

According to the user operation, the billing allowable range start position passing time, the billing allowable range end position passing time, and the billing time are confirmed. The billing location detection unit 352 determines whether a location of the target vehicle is within the billing allowable range using the method described with reference to FIGS. 30 to 33 and acquires the determination result as billing location information.

The process (here, one process of Steps S353 to S354) for one vehicle 320 has been completed above.

Further, similarly, the processes of Steps S353 to S354 are performed on another target vehicle in the loop L3.

As described above, the camera 326 is mounted on the vehicle 320, and images the outside from the vehicle 320 at a timing at which the billing process has been performed based on a location of the vehicle 320.

Accordingly, in the information presentation system for evaluating a billing location 3, it is possible to provide information for evaluating a billing location at relatively low cost without an expensive device such as a high accuracy location determining device.

In addition, in the information presentation system for evaluating a billing location 3, there is no need to perform special adjustment of a device to be mounted on the vehicle 320. In particular, even when the billing location is evaluated for a plurality of vehicles, the burden on an operator who installs the device in the vehicles 320 is relatively small.

In addition, the billing location detection unit 352 determines a relationship between a location at which the camera 326 has performed imaging and a location at which an image stored in the storage unit 149 is captured according to the association of images of the same object included in the image captured by the camera 326 and the image stored in the storage unit 149.

Accordingly, in the information presentation system for evaluating a billing location 3, it is possible to provide the billing location information to the user. In particular, the user can more easily determine the billing location than when the camera 326 provides an image captured from the billing location.

Here, the vehicle 320 may have an omnidirectional camera, or may have a plurality of cameras as the camera 326 in order to capture images in both left and right directions. Accordingly, when either of left and right fields of view is blocked and it is not possible to capture an image of the roadside, for example, in a case in which another vehicle is located adjacently, the camera 326 can capture an image of the roadside on the other side. The billing location detection unit 352 can detect the billing location from this image.

### Modification of Third Embodiment

Markers that can be distinguished from other objects may be installed at a billing allowable range start point and a billing allowable range end point on the roadside.

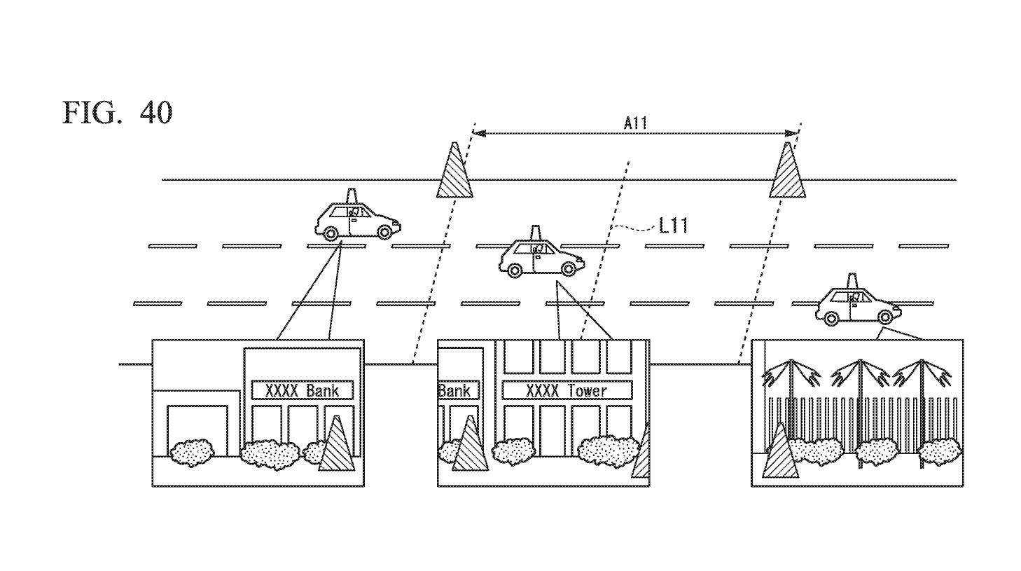

FIG. 40 is an explanatory diagram showing an example of the image captured by the camera 326 when a marker is installed on the roadside.

In the example in FIG. 40, pylons are installed as markers at the billing allowable range start point and the billing allowable range end point on the roadside. The image of the pylon is also included in the image captured by the camera 326. The billing location detection unit 352 or the user may detect a specific shape (a triangle in the example in FIG. 40) of the mark, and can detect the billing location according to a relatively simple process.

In addition, in the example in FIG. 40, pylons with different colors are installed at the billing allowable range start point and the billing allowable range end point. Accordingly, the billing location detection unit 352 or the user can distinguish the billing allowable range start point and the billing allowable range end point by color.

Here, the marker here is not limited to a pylon, and various items for which image matching is relatively easy such as a pole and a dedicated sign can be used.

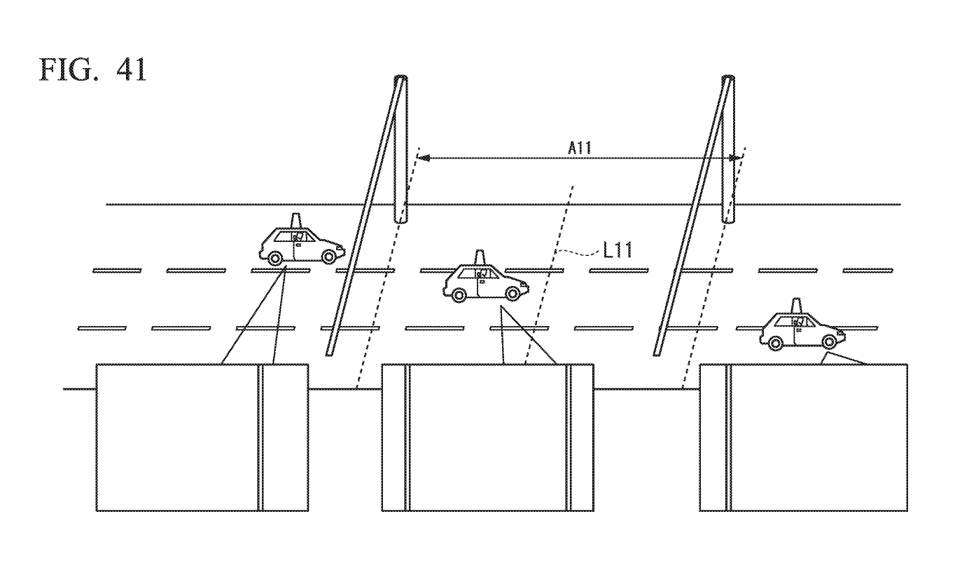

In addition, the camera 326 may be installed pointing upward and may capture an image above the vehicle 320. In this case, markers may be installed above the road at the billing allowable range start point and the billing allowable range end point. FIG. 41 is an explanatory diagram showing an example of the image captured by the camera 326 when a marker is installed above the road.

In the example in FIG. 41, bars are installed as markers above the road at the billing allowable range start point and the billing allowable range end point, and the image of the bar is also included in the image captured by the camera 326.

Above the road, a field of view is not blocked in other directions so that the camera 326 can capture an image of the marker more reliably. Accordingly, it is possible to reduce a likelihood of the billing location detection unit 352 failing to detect the billing location.

Here, instead of a bar, a laser beam may be emitted as the mark so that the camera 326 can receive the beam. Accordingly, there is no need to install bars over the width of the road, and a marker installation operation becomes easier.

In addition, a near infrared laser beam may be used as a laser beam, and a near infrared camera may be used as the camera 326. Accordingly, the camera 326 can image the marker even if direct sunlight is emitted.

Here, processes of units may be performed such that a program for implementing all or some functions of the control unit 150, 250, or 350 is recorded in computer readable recording media and a computer system reads and executes the program recorded in the recording media. The term “computer system” used herein includes an OS or hardware such as peripheral devices.

In addition, the “computer system” also includes a website providing environment (or a display environment) as long as it uses the WWW system.

In addition, the term “computer readable recording media” includes portable media such as a flexible disk, a magneto-optical disc, and a compact disk, and non-temporary storage media represented by a storage device such as a hard disk built into a computer system. Moreover, the “computer readable recording media” include temporary storage media that dynamically maintain a program for a short time like a communication line when a program is transmitted via a network such as the Internet or a communication line such as a telephone line, and non-temporary storage media that maintain a program for a certain time like a volatile memory in the computer system serving as a server or a client. In addition, the program may be a program for implementing some of the above-described functions, and the above-described functions may be implemented in a combination with a program already recorded in the computer system.

The embodiments of the present invention have been described in detail above with reference to the drawings, but specific configurations are not limited to the embodiments, and design changes and the like in the range without departing from the spirit and scope of the invention are included.

### INDUSTRIAL APPLICABILITY

The present invention relates to an information presentation system for evaluating a billing location including a signal output unit mounted on a vehicle and configured to output a signal at a timing at which a billing process is performed based on a location of the vehicle; a signal acquisition unit installed at a predetermined location and configured to acquire a signal from the signal output unit; and a billing location detection unit configured to detect a location at which the billing process is performed based on the signal acquired by the signal acquisition unit.

According to the above-described information presentation system for evaluating a billing location, it is possible to provide information for evaluating a location at which the billing process has been performed at relatively low cost.

### REFERENCE SIGNS LIST

1, 2, 3 Information presentation system for evaluating billing location
110 Billing server device
120, 220, 320 Vehicle
121, 221 On-vehicle device
122 Signal output control device
123 Lighting device
130 Location detection system
131, 132, 326 Camera
140, 240, 340 Location detection device
141 Display unit
142 Operation input unit
143 Unit for communication with billing server
144 Image acquisition unit
149 Storage unit
150, 250, 350 Control unit
151 Storage unit management unit
152, 252, 352 Billing location detection unit
153 Count processing unit
224 Acceleration sensor
225 Acceleration recording device
245 Unit for communication with vehicle
327 Camera control device

1. An information presentation system for evaluating a billing location comprising:
a signal output unit mounted on a vehicle and configured to output a signal at a timing at which a billing process has been performed based on a location of the vehicle;
a signal acquisition unit installed at a predetermined location and configured to acquire a signal from the signal output unit; and
a billing location detection unit configured to detect a location at which the billing process has been performed based on the signal acquired by the signal acquisition unit.

2. The information presentation system for evaluating a billing location according to claim 1,
wherein the signal output unit includes a lighting device and outputs light as the signal,
wherein the signal acquisition unit includes a camera and captures an image including an image of the vehicle, and
wherein the billing location detection unit detects a location at which the billing process has been performed based on a location of an image of the vehicle which is included in the image and in which the lighting device is turned on.

3. The information presentation system for evaluating a billing location according to claim 1,
wherein the signal output unit outputs a sound as the signal,
wherein the signal acquisition unit includes a microphone and acquires a sound from the signal output unit, and
wherein the billing location detection unit detects a location at which the billing process has been performed based on sound information acquired by the signal acquisition unit.

4. The information presentation system for evaluating a billing location according to claim 1,
wherein the signal output unit outputs light having directionality as the signal,
wherein the signal acquisition unit includes a plurality of light receiving sensors that are provided along a traveling path of the vehicle and are able to acquire the light, and
wherein the billing location detection unit detects a location at which the billing process has been performed based on a light receiving sensor that is used for the signal acquisition unit to acquire the light.

5. An information presentation system for evaluating a billing location comprising:
a billing processing unit configured to perform a billing process based on a location of a vehicle;
a force detection unit configured to detect a force applied to the vehicle due to a change in height of a surface provided at a predetermined location on a path along which the vehicle travels; and
a billing location detection unit configured to detect a location at which the billing process has been performed based on a timing at which the billing processing unit has performed the billing process and a timing at which the force detection unit detects the force applied.

6. The information presentation system for evaluating a billing location according to claim 5,
wherein the force detection unit detects a force applied to the vehicle when traveling due to a change in height of the surface provided at two places on a path along which the vehicle travels, and
wherein the billing location detection unit detects whether a location at which the billing process has been performed is included in a range having the two places as two ends thereof.

7. The information presentation system for evaluating a billing location according to claim 6,
wherein the force detection unit detects a force applied to the vehicle when traveling due to a change in height of the surface that is additionally provided between the two places, and
wherein the billing location detection unit detects a section in which a location at which the billing process has been performed is included among sections of the path along which the vehicle travels that are separated by a change in height of the surface.

8. An information presentation system for evaluating a billing location comprising
an imaging unit mounted on a vehicle and configured to image the outside from the vehicle at a timing at which a billing process has been performed based on a location of the vehicle.

9. The information presentation system for evaluating a billing location according to claim 8, comprising
a storage unit configured to store an image captured from a predetermined location; and
a billing location detection unit configured to detect a location at which the billing process has been performed,
wherein the billing location detection unit determines a relationship between a location at which the imaging unit has performed imaging and a location at which an image stored in the storage unit is captured according to the association of images of the same object included in the image captured by the imaging unit and the image stored in the storage unit.

10. The information presentation system for evaluating a billing location according to claim 8,
wherein a predetermined marker is provided at a predetermined reference location.

11. The information presentation system for evaluating a billing location according to claim 8,
wherein a predetermined marker is provided above a path along which the vehicle travels, and
wherein the imaging unit is installed pointing upward and performs imaging.
